(19) United States
(12) Patent Application Publication
(10) Pub. No.: US 2021/0200109 A1
(43) Pub. Date: Jul. 1, 2021

(54) IMAGE FORMING APPARATUS, PROCESS CARTRIDGE, CARTRIDGE SET, AND IMAGE FORMING METHOD

(71) Applicant: CANON KABUSHIKI KAISHA, Tokyo (JP)

(72) Inventors: Daisuke Yoshiba, Shizuoka (JP); Tetsuya Kinumatsu, Shizuoka (JP); Mariko Yamashita, Shizuoka (JP); Michiyo Sekiya, Shizuoka (JP)

(21) Appl. No.: 17/130,810

(22) Filed: Dec. 22, 2020

(30) Foreign Application Priority Data
Dec. 26, 2019 (JP) 2019237079

(51) Int. Cl. G03G 9/087; G03G 9/08; G03F 7/032

(52) U.S. Cl. CPC G03G 9/08708; G03G 9/08782; G03F 7/032; G03G 9/0821; G03G 9/0819

(57) ABSTRACT

An image forming apparatus comprising an electrophotographic photosensitive member and a developing device comprising a toner, the developing device being for supplying the toner to the electrophotographic photosensitive member, wherein the electrophotographic photosensitive member comprises a surface layer comprising a binder resin (A), the binder resin (A) comprises a specific structure, the toner comprises a toner particle, the toner particle comprises a binder resin (B) and a wax, and the wax has a value δp(w) of a polarity term based on Hansen solubility parameters of 1.8 (J/cm³)^{0.5} to 2.5 (J/cm³)^{0.5}, as well as a process cartridge, a cartridge set and an image forming method.

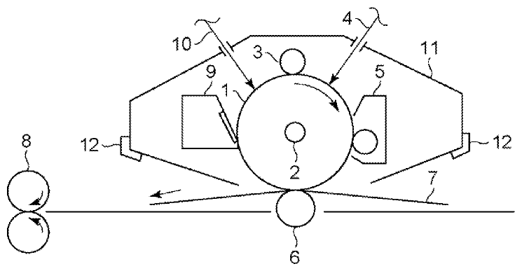

### BACKGROUND OF THE INVENTION

### Field of the Invention

The present disclosure relates to an image forming apparatus, a process cartridge, a cartridge set, and an image forming method.

### Description of the Related Art

Conventionally, a large number of methods are known for image forming apparatuses and image forming methods using electrophotography. An example of an image forming method is as follows.

An electrical latent image is formed on an electrophotographic photosensitive member (hereinafter also referred to as a photosensitive member) according to various means by using a photoconductive material. Next, the electrical latent image is developed using a toner to generate a toner image, and the toner image is transferred to a transfer material, such as paper, as necessary. Thereafter, the toner image is fixed to the transfer material using heat, pressure and the like, thereby obtaining a fixed image.

Here, the toner remaining on the photosensitive member without being transferred to the transfer material is cleaned off through various methods after transfer, as necessary.

Recently, there has been demand for lower power consumption and further enhancement in image quality in laser printers and copying machines. To cope with demand for lower power consumption, a toner which rapidly melts at a low temperature, that is, a toner which has excellent low-temperature fixability is desirable. To obtain a toner having excellent low-temperature fixability, research on using a wax for the toner has been conducted.

For example, a toner with improved low-temperature fixability, hot-offset resistance and heat resistant storage stability utilizing a diester compound as a wax has been proposed in WO 2013/047296.

### SUMMARY OF THE INVENTION

There are cases in which a wax is added for the purpose of providing releasability to a toner, but a wax also may be added for the purpose of providing plasticity to a binder resin. The compatibility of the binder resin and the wax may be controlled such that a wax is melted and liquefied by heat and plasticizes the binder resin and the viscosity during melting of the toner decreases, and thus a toner having excellent low-temperature fixability can be acquired.

As a wax having excellent plasticity, a wax having a molecular structure with high polarity and high mobility is desirably used, and this also greatly improves the low-temperature fixability.

On the other hand, the wax in a toner greatly affects the charging performance and adhesiveness of the toner. Particularly, in a transfer process that has an influence on the acquisition of a high image quality, the toner is easily influenced by the wax.

Specifically, it has been found that there are cases in which when a transfer voltage is applied to a toner during transfer, a wax with high polarity easily becomes locally charged and the electrostatic attachment force with a photosensitive member temporarily increases, and thus transfer is hindered and an image defect may be generated. This image defect is particularly notable in a line image and is called “omission during transfer” because a part (mostly a center part) of a line is omitted. Such an omission during transfer may be a problem as higher image quality is required.

Since it has been found that omission during transfer easily becomes noticeable in a wax having high polarity and high compatibility, there is need for implementing both the low-temperature fixability and high-definition image quality with reduced omission during transfer.

However, WO 2013/047296 is effective to improve the low-temperature fixability, but does not examine in detail the relationship between the toner and the photosensitive member, hence there is room for improvement with respect to omission during transfer.

The present disclosure provides an image forming apparatus, a process cartridge, a cartridge set, and an image forming method which have excellent low-temperature fixability and with which high-definition images with reduced omission during transfer can be acquired.

A first image forming apparatus of the present disclosure for solving the problems is an image forming apparatus comprising:

an electrophotographic photosensitive member; and

a developing device comprising a toner, the developing device being for supplying the toner to the electrophotographic photosensitive member, wherein

the electrophotographic photosensitive member comprises a surface layer comprising a binder resin (A),

the binder resin (A) comprises a structure represented by the following formula (1):

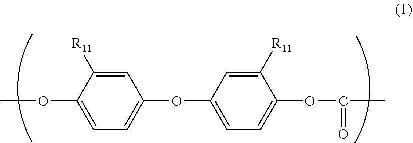

where, each R₁₁ independently represents a hydrogen atom or a methyl group,

the toner comprises a toner particle,

the toner particle comprises a binder resin (B) and a wax, and

the wax has a value δp(w) of a polarity term based on Hansen solubility parameters of 1.8 to 2.5 (J/cm³)^{0.5}.

A second image forming apparatus of the present disclosure is an image forming apparatus comprising:

an electrophotographic photosensitive member; and

a developing device comprising a toner, the developing device being for supplying the toner to the electrophotographic photosensitive member, wherein

the electrophotographic photosensitive member comprises a surface layer comprising a binder resin (A),

the binder resin (A) comprises a structure represented by the following formula (1):

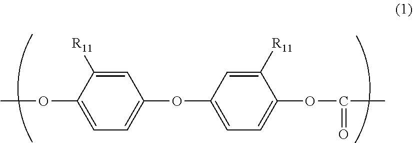

where, each R₁₁ independently represents a hydrogen atom or a methyl group,
the toner comprises a toner particle,
the toner particle comprises a binder resin (B) and a wax, and
the wax comprises a diester compound represented by the following formula (3):

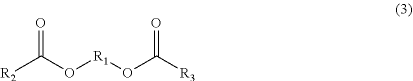

where, R₁ represents an alkylene group having a number of carbon atoms of 1 to 3, and R₂ and R₃ independently represent alkylene groups having a number of carbon atoms of 15 to 22.

In addition, a process cartridge of the present disclosure is a process cartridge attached detachably to a main body of an image forming apparatus, the process cartridge comprising:

an electrophotographic photosensitive member; and

a developing device comprising a toner, the developing device being for supplying the toner to the electrophotographic photosensitive member, wherein

the electrophotographic photosensitive member comprises a surface layer comprising a binder resin (A),

the binder resin (A) comprises a structure represented by the following formula (1):

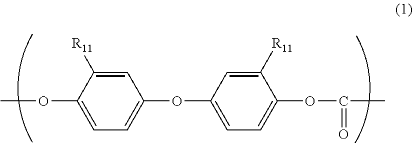

where, each R₁₁ independently represents a hydrogen atom or a methyl group,

the toner comprises a toner particle,

the toner particle comprises a binder resin (B) and a wax, and

the wax has a value δp(w) of a polarity term based on Hansen solubility parameters of 1.8 to 2.5 (J/cm³)^{0.5}.

Further, a cartridge set of the present disclosure is a cartridge set comprising a first cartridge and a second cartridge attached detachably to a main body of an image forming apparatus, wherein

the first cartridge comprises an electrophotographic photosensitive member,

the second cartridge comprises a toner container comprising a toner for developing an electrostatic latent image formed on a surface of the electrophotographic photosensitive member to form a toner image on the surface of the electrophotographic photosensitive member,

the electrophotographic photosensitive member comprises a surface layer comprising a binder resin (A),

the binder resin (A) comprises a structure represented by the following formula (1):

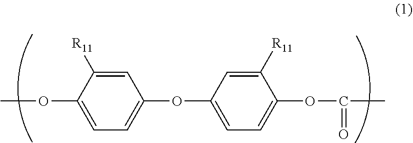

where, each R₁₁ independently represents a hydrogen atom or a methyl group,

the toner comprises a toner particle,

the toner particle comprises a binder resin (B) and a wax, and

the wax has a value δp(w) of a polarity term based on Hansen solubility parameters of 1.8 to 2.5 (J/cm³)^{0.5}.

Furthermore, an image forming method of the present disclosure is an image forming method in which an electrophotographic photosensitive member and a toner are used,

the method comprising a developing process of supplying the toner to the electrophotographic photosensitive member, wherein

the electrophotographic photosensitive member comprises a surface layer comprising a binder resin (A),

the binder resin (A) comprises a structure represented by the following formula (1):

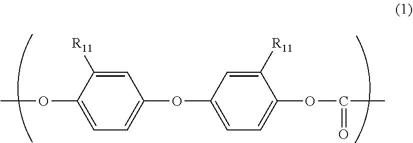

where, each R₁₁ independently represents a hydrogen atom or a methyl group,

the toner comprises a toner particle,

the toner particle comprises a binder resin (B) and a wax, and

the wax has a value δp(w) of a polarity term based on Hansen solubility parameters of 1.8 to 2.5 (J/cm³)^{0.5}.

According to the present disclosure, an image forming apparatus, a process cartridge, a cartridge set, and an image forming method which have excellent low-temperature fixability and with which high-definition images with reduced omission during transfer can be acquired are provided.

Further features of the present invention will become apparent from the following description of exemplary embodiments with reference to the attached drawings.

### BRIEF DESCRIPTION OF THE DRAWINGS

The FIGURE is an example of an image forming apparatus.

### DESCRIPTION OF THE EMBODIMENTS

In the present disclosure, the statement “from XX to YY” and “XX to YY” representing a numerical value range means a numerical value range including a lower limit and an upper limit that are endpoints unless otherwise particularly noted.

The present inventors have performed diligent research with respect to an image forming apparatus or the like which can curb omission during transfer in addition to having excellent low-temperature fixability.

First, the present inventors examined a wax in order to obtain a toner having excellent the low-temperature fixability.

As described above, although there are cases in which a wax is added for the purpose of providing releasability to the toner, it can be added for the purpose of providing plasticity to a binder resin. The compatibility of the binder resin and the wax is controlled such that the wax that has melded and liquefied by heat plasticizes the binder resin and the viscosity during melting of the toner decreases, and thus a toner having excellent low-temperature fixability can be acquired.

As a wax having excellent plasticity, a wax having a molecular structure with high polarity and high mobility is desirably used and this also greatly improves the low-temperature fixability. On the other hand, when the polarity of the wax excessively high, it is necessary to control the polarity such that it is an appropriate polarity because otherwise it is difficult to control plasticity and the storage stability of the toner easily decreases.

According to the results of diligent research, the present inventors use a value δp(w) which is a polarity term based on a Hansen solubility parameter of a wax as an index of the polarity of a wax. It was discovered that the low-temperature fixability and the storage stability were compatible when δp(w) is from 1.8 (J/cm³)^{0.5} to 2.5 (J/cm³)^{0.5}.

The Hansen solubility parameter is a three-dimensional vector quantity composed of a dispersion term, a polarity term, and a hydrogen bond term. When the value of the dispersion term of the Hansen solubility parameter of a certain material is δd, the value of the polarity term is δp, and the value of the hydrogen bond term is δh, the Hansen solubility parameter is represented as [δd, δp, δh] in the present specification.

The present inventors discovered that the value δp(w) of the polarity term based on the Hansen solubility parameter which can be used as an index of the polarity of a wax was able to be used as an index of the low-temperature fixability and the storage stability of an image forming apparatus or the like.

The value (δp) of the polarity term based on the Hansen solubility parameter may be calculated using the solubility parameter calculation software “Hansen Solubility Parameters in Practice 4th Edition 4.1.03 (available through https://www.hansen-solubility.com/HSPiP/)”. The calculation method is based on Hansen solubility parameter theory, and the chemical structural formula of a compound is input and calculation is performed to obtain the value (δp) [(J/cm³)^{0.5}] of the polarity term. A detailed calculation method will be described later.

Meanwhile, the wax in a toner seriously affects the charging performance and adhesiveness of the toner, as described above. Particularly, in a transfer process that affects having high image quality, the toner is easily influenced by the wax.

As described above, a wax has a relatively high polarity, specifically, δp(w) is from 1.8 (J/cm³)^{0.5} to 2.5 (J/cm³)^{0.5} in terms of the low-temperature fixability. On the other hand, a wax in a toner is present in a state in which it is dispersed in a binder resin, in general. When a wax with high polarity having biased charges is present in the toner in this manner, it has been ascertained that charging of the toner easily becomes un-uniform, which has various effects. Specifically, it has been ascertained that there are cases in which the wax becomes locally charged and an electrostatic attachment force with respect to the photosensitive member temporarily increases to hinder transfer and generate an image defect when a transfer voltage is applied to the toner during transfer, as described above. This image defect is particularly notable in a line image and is called “omission during transfer” because a part (mostly the center part) of a line is omitted, as described above. Such omission during transfer may be a problem when high image quality is required.

Accordingly, the present inventors conducted diligent research on a relationship between the wax and the surface layer of a photosensitive member used for a toner and examined curbing the increase in a temporary attachment force when the transfer voltage is applied.

As a result, it was discovered that the aforementioned problem was able to be solved when the photosensitive member has a surface layer including a binder resin having a specific structure.

Here, “surface layer” is a layer positioned on the outermost surface of the photosensitive member and the outer surface of the surface layer comes into contact with the toner.

That is, the photosensitive member used in the present disclosure comprises a surface layer comprising a binder resin (A), and the binder resin (A) comprises a structure represented by the following formula (1).

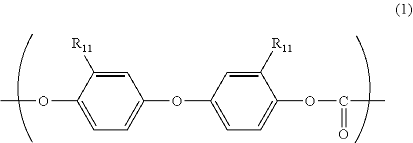

In formula (1), each R₁₁ independently represents a hydrogen atom or a methyl group.

The binder resin (A) comprises a structure represented by the above formula (1). That is, the binder resin (A) is classified as a polycarbonate resin.

A polycarbonate resin is desirably used as a binder resin of the photosensitive member because it has excellent abrasion resistance. In a general polycarbonate structure, a quaternary carbon instead of an oxygen atom can be present between two phenylene groups in the structure represented by the above formula (1).

On the other hand, the binder resin (A) may comprise a structure in which the quaternary carbon is substituted with oxygen, that is, the structure represented by the above formula (1).

The polarity of the structural unit is higher in the structure represented by the above formula (1) as compared to a structure in which a quaternary carbon is present instead of an oxygen atom. Consequently, it is possible to curb temporary increase in the electrostatic attachment force between the photosensitive member and the toner when the transfer voltage has been applied because the polarity of the wax used for the toner becomes relatively close thereto, and thus omission during transfer can be significantly improved.

In addition, in formula (1) each R₁₁ independently represents a hydrogen atom or a methyl group. The solubility of the binder resin (A) with respect to a solvent and abrasion resistance are improved when the surface layer (desirably, photosensitive layer) of the photosensitive member is formed by allowing R₁₁ to have the aforementioned structure.

As described above, in the present disclosure, it is possible to make the low-temperature fixability and omission during transfer highly compatible by using an image forming apparatus which appropriately controls a relationship between the polarity of a wax used for a toner and the polarity of a resin included in the surface layer of a photosensitive member.

Hereinafter, the present disclosure will be described in more detail.

The toner comprises toner particles and the toner particles comprise a binder resin (B) and a wax. The wax has a value δp(w) of a polarity term based on Hansen solubility parameters of 1.8 to 2.5 (J/cm³)^{0.5}.

There are no other limitations on the wax if δp(w) thereof is within the aforementioned range, and a known wax can be used. Specifically, ethylene glycol distearate, trimethylene glycol distearate, ethylene glycol dibehenate, and the like are conceivable, for example. In addition, a commercially available wax such as DP-16 (palmitate of dipentaerythritol manufactured by The Nisshin OilliO Group, Ltd.) can also be used.

δp(w) is desirably from 1.8 (J/cm³)^{0.5} to 2.3 (J/cm³)^{0.5} and more desirably from 1.9 (J/cm³)^{0.5} to 2.2 (J/cm³)^{0.5}. δp(w) can be controlled by changing the type of a monomer that is a raw material of a compound included as the wax, and the type, content, and the like of the compound included as the wax, or the like.

It is desirable that the wax comprise a diester compound represented by the following formula (3) (hereinafter also referred to as simply “diester compound”).

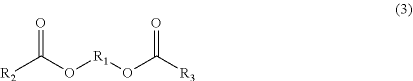

In formula (3), R₁ represents an alkylene group having a number of carbon atoms of from 1 to 3, desirably an alkylene group having a number of carbon atoms of from 2 to 3, more desirably an ethylene group or a trimethylene group, and further desirably an ethylene group. In addition, R₂ and R₃ independently represent alkyl groups (desirably straight-chain alkyl groups) having a number of carbon atoms of from 15 to 22. The number carbon atoms of the alkyl groups (desirably straight-chain alkyl groups) is desirably at least 16 and further desirably at least 17. In addition, more desirably the number of carbon atoms is not more than 21. These numerical value ranges can be arbitrarily combined.

The wax comprises the diester compound represented by formula (3) and thus δp(w) is easily controlled such that it is within the aforementioned range. In addition, since the structure represented by formula (3) has an adequate molecule size, a speed of compatibilization with respect to the binder resin (B) increases and a plasticizing effect is obtained more rapidly and thus the low-temperature fixability is further improved.

The alkylene group having a number of carbon atoms of from 1 to 3 represented by R₁ (desirably an alkylene group having a number of carbon atoms of from 2 to 3) may have substituents.

Specifically, although the following compounds are conceivable as the diester compound represented by the above formula (3), the present disclosure is not limited thereto.

Ethylene glycol distearate (R₁═—C₂H₄—, R₂═R₃═—C₁₇H₃₅), trimethylene glycol distearate (R₁═—C₃H₆—, R₂═R₃═—C₁₇H₃₅), ethylene glycol arachidinate stearate (R₁═—C₂H₄—, R₂═—C₁₉H₃₉, R₃═—C₁₇H₃₅), trimethylene glycol arachidinate stearate (R₁═—C₃H₆—, R₂═—C₁₉H₃₉, R₃═—C₁₇H₃₅), ethylene glycol stearate palmitate (R₁═—C₂H₄—, R₂═—C₁₇H₃₅, R₃═—C₁₅H₃₁), trimethylene glycol stearate palmitate (R₁═—C₃H₆—, R₂═—C₁₇H₃₅, R₃═—C₁₅H₃₁), ethylene glycol dipalmitate (R₁═—C₂H₄—, R₂═R₃═—C₁₅H₃₁), trimethylene glycol dipalmitate (R₁═—R₂═R₃═—C₁₅H₃₁), ethylene glycol dimargarate (R₁═—C₂H₄—, R₂═R₃═—C₁₆H₃₃), trimethylene glycol dimargarate (R₁═R₂═R₃═—C₁₆H₃₃), ethylene glycol dinonadecanate (R₁═—C₂H₄—, R₂═R₃═—C₁₈H₃₇), trimethylene glycol dinonadecanate (R₁═—C₃H₆—, R₂═R₃=—C₁₈H₃₇), ethylene glycol diarachidinate (R₁═—C₂H₄—, R₂═R₃═—C₁₉H₃₉), trimethylene glycol diarachidinate (R₁═R₂═R₃═—C₁₉H₃₉), ethylene glycol dibehenate (R₁═—C₂H₄—, R₂═R₃═—C₂₁H₄₃), and trimethylene glycol dibehenate (R₁═—C₃H₆—, R₂═R₃═—C₂₁H₄₃).

From among these diester compounds, ethylene glycol distearate and trimethylene glycol distearate are more desirable.

If the wax comprises the diester compound represented by the above formula (3) as a main ingredient, the effects of the present disclosure can be easily acquired. Specifically, the content of the diester compound in the wax is desirably from 50 mass % to 100 mass % and more desirably from 95 mass % to 100 mass %.

In addition, the content of the wax is desirably from 5 parts by mass to 30 parts by mass and more desirably from 10 parts by mass to 30 parts by mass with respect to 100 parts by mass of the binder resin (B). The effects of the present disclosure are stably acquired when at least 5 parts by mass of the wax is included. On the other hand, compatibility with storage stability is easily achieved when the content of the wax is not more than 30 parts by mass.

The wax may comprise other waxes.

Specifically, the following waxes may be exemplified as other waxes.

Multifunctional ester waxes such as: aliphatic hydrocarbons such as low-molecular-weight polyethylene, low molecular weight polypropylene, microcrystalline wax, paraffin wax, and Fischer-Tropsch wax; pentaerythritol ester compounds such as pentaerythritol tetrapalminate, pentaerythritol tetrabehenate, and pentaerythritol tetrastearate; glycerin ester compounds such as hexaglycerin tetrabehenate tetrapalminate, hexaglycerin octabehenate, pentaglycerin heptabehenate, tetraglycerin hexabehenate, triglycerin pentabehenate, diglycerin tetrabehenate, and glycerin tribehenate; and dipentaerythritol ester compounds such as dipentaerythritol hexamyristate are conceivable.

The acid value of the wax is desirably from 0.01 mg KOH/g to 2.0 mg KOH/g, more desirably from 0.03 mg KOH/g to 1.0 mg KOH/g, and further desirably from 0.05 mg KOH/g to 0.5 mg KOH. Meanwhile, the acid value of the wax is a value measured in conformity to JIS K 0070 using a method of testing acid values of chemical products established by Japanese Industrial Standards. The measurement method will be described in detail later.

When the acid value of the wax is from 0.01 mg KOH/g to 2.0 mg KOH/g, droplets of a polymerizable monomer composition tend to be easily formed with stability in a droplet forming process because an adequate number of carboxylic acid groups derived from unreacted fatty acid are present in the wax. As a result, a particle diameter of the toner particles easily becomes uniform.

The hydroxyl value of the wax is desirably from 0.1 mg KOH/g to 15 mg KOH/g, more desirably from 0.3 mg KOH/g to 10 mg KOH/g, further desirably 0.5 mg KOH/g to 5.0 mg KOH/g, and especially desirably from 1.0 mg KOH/g to 4.0 mg KOH/g. Meanwhile, the hydroxyl value of the wax is a value measured in conformity to JIS K 0070 using a method of testing hydroxyl values of chemical products established by Japanese Industrial Standards.

When the hydroxyl value of the wax is from 0.1 mg KOH/g to 15 mg KOH/g, droplets of a polymerizable monomer composition tend to be easily formed with stability in a droplet forming process because an adequate number of carboxyl groups derived from unreacted raw materials are present in the wax. As a result, a particle diameter of the toner particles easily becomes uniform.

Although a method of manufacturing the diester compound represented by the above formula (3) is not particularly limited, in the case of an ester wax, for example, a synthesis method using an oxidation reaction, synthesis from a carboxylic acid and derivatives thereof, an ester group introduction reaction represented by a Michael addition reaction, a method using a dehydrating condensation reaction of a carboxylic acid compound and an alcohol compound, a reaction of an acid halide compound and an alcohol compound, a transesterification, and the like are conceivable.

An appropriate catalyst can be used to manufacture the diester compound. As the catalyst, a general acid or alkaline catalyst used for esterification, for example, zinc acetate, a titanium compound, and the like are desirable. A target product may be refined through recrystallization, distillation, or the like after esterification.

Although a specific example of manufacturing the diester compound represented by the above formula (3) will be described below, the present disclosure is not limited to the manufacturing example below.

First, an alcohol monomer and a carboxylic acid monomer that are raw materials are added to a reactor. The molar ratio between the alcohol monomers and the carboxylic acid monomers is appropriately adjusted in accordance with the chemical structure of the diester compound that is a target. That is, the alcohol monomers and the carboxylic acid monomers are mixed such that the molar ratio becomes alcohol monomer:carboxylic acid monomer=1:2. Meanwhile, any either of the alcohol monomer and the carboxylic acid monomer may be added in a proportion slightly exceeding that in the aforementioned ratio in consideration of reactivity in the dehydrate condensation reaction.

Next, the mixture of the alcohol monomer and the carboxylic acid monomer is appropriately heated such that the dehydrate condensation reaction occurs. A basic aqueous solution and an appropriate organic solvent are added to an esterified crude product obtained by the dehydrate condensation reaction such that unreacted alcohol monomers and carboxylic acid monomers are deprotonated and separated into an aqueous phase. Thereafter, appropriate washing, solvent distillation, and filtration are performed to obtain a desired diester compound.

In addition, the melting point of the wax is desirably from 65° C. to 85° C. and more desirably from 70° C. to 80° C.

The storage stability and the low-temperature fixability of the toner easily become compatible by setting the melting point in the aforementioned ranges.

The toner comprises toner particles. The toner particles comprise a binder resin (B) and the aforementioned wax. The binder resin (B) is not particularly limited and a known resin for the toner can be used.

Specifically, as resins desirably used, from among a vinyl resin, styrene resin, styrene copolymer resin, polyester resin, polyol resin, polyvinyl chloride resin, phenol resin, natural resin modified phenol resin, natural resin modified maleic acid resin, acrylic resin, methacrylic resin, polyvinyl acetate, silicone resin, polyurethane resin, polyamide resin, furan resin, epoxy resin, xylene resin, polyvinyl butyral, terpene resin, coumarone indene resin, and petroleum resin, there are a styrene copolymer resin, a polyester resin, and a hybrid resin obtained by mixing a polyester resin and a vinyl resin or by partial reaction of these, and the like.

Among these, a vinyl resin is desirable and a styrene copolymer resin is more desirable in terms of compatibility with the wax.

In addition, the content of the binder resin (B) in the toner is desirably from 40 mass % to 95 mass %.

When the SP value of the binder resin (B) is defined as SP1 ((J/cm³)^{0.5}), and the SP value of the wax is defined as SP2 ((J/cm³)^{0.5}), it is desirable that the SP1 and the SP2 satisfy the following formula (2).

1.80≤SP1−SP2≤2.10 (2)

Here, the SP value is an abbreviation for solubility parameter (or, soluble parameter) and is an index of solubility.

The compatibility of the binder resin (B) and the wax can be represented by the relationship between these SP values.

It is possible to appropriately control the compatibility between the wax and the binder resin (B) by controlling the relationship between the SP values of the wax and the binder resin such that they are within the range of the above formula (2), and thus the low-temperature fixability and the storage stability easily become compatible. The value of SP1-SP2 is from 1.90 to 2.05 more desirably.

When SP1-SP2 is not more than 2.10, the compatibility tends to increase to cause the low-temperature fixability to be improved. When SP1-SP2 is at least 1.80, excessive plasticization is curbed and thus the storage stability tends to hardly decrease.

In addition, SP1 is desirably from 19.00 to 21.00 and more desirably from 19.50 to 21.50.

Further, SP2 is desirably from 18.00 to 18.50 and more desirably from 18.00 to 18.45.

SP1 can be controlled by changing types, contents and the like of monomers that are raw materials of a compound included as the binder resin, and the like.

In addition, SP2 can be controlled by changing types of monomers that are raw materials of a compound included as the wax, and the type, content and the like of the compound included as the wax, and the like.

When SP1 and SP2 are obtained as follows according to the calculation method proposed by Fedors.

With respect to the binder resin (B) and the wax, a vaporization energy Δei (cal/mol) and a molar volume Δvi (cm³/mol) are obtained from tables shown in “polym. Eng. Sci., 14 (2), 147-154 (1974)” for atoms or atom groups in the molecular structure, and the value of (4.184×ΣΔei/ΣΔvi)^{0.5} is set to an SP value (J/cm³)^{0.5}.

Meanwhile, when a plurality of compounds are included in the wax, the SP2 value is obtained by weighted averaging of SP2 values of the respective compounds.

For example, the SP2 value when A mol % of a wax having an SP2 value of SP2_{A} is included on the basis of the number of moles of all compounds included as the wax and (100−A) mol % of a compound having an SP2 value of SP2_{B} is included on the basis of the number of moles of the all compounds included as the wax is SP2═(SP2_{A}×A+SP2_{B}×(100−A))/100. In a case where the number of compounds included as the wax is at least 3, calculation is performed in the same manner.

In addition, although the toner includes toner particles, the toner particles are not particularly limited as long as they include a wax having a value δp(w) within the aforementioned range, and a method of manufacturing the toner particles is not particularly limited.

The toner particles can be manufactured through a pulverization method and also manufactured through a method of manufacturing the toner particles in an aqueous medium, such as a dispersion polymerization method, an association aggregation method, a fusion suspension method, a suspension polymerization method, or an emulsion aggregation method.

However, the method of manufacturing the toner particles in an aqueous medium is desirable from the viewpoint of control of a physical state of the wax, and it is particularly desirable to manufacture the toner particles through a suspension polymerization method from the viewpoint of toner shape control.

Hereinafter, the suspension polymerization method will be described.

According to the suspension polymerization method, a polymerizable monomer composition is obtained by uniformly dissolving or dispersing a polymerizable monomer and a wax (additionally a colorant, a polymerization initiator, a crosslinking agent, a charge control agent, and other additives as necessary). Thereafter, the polymerizable monomer composition is dispersed using an appropriate agitator in a continuous layer (e.g., aqueous phase) containing a dispersing agent, and simultaneously, polymerization reaction is caused to occur to obtain toner particles having a desired particle diameter. In the toner particles (hereinafter referred to as “polymerized toner particles”) obtained through this suspension polymerization method, individual toner particle shapes are all alike and have an approximately spherical form, and thus a charge amount distribution is relatively uniform so that image quality is expected to be improved.

In a method of manufacturing toner particles using the suspension polymerization method, a wax having δp(w) within the aforementioned range is used.

In manufacture of polymerized toner particles, the following are conceivable as polymerizable monomers constituting a polymerizable monomer composition.

It is desirable to use a monovinyl monomer as the polymerizable monomer. As a monovinyl monomer, for example, styrene; styrene derivatives such as vinyltoluene and α-methylstyrene; acrylic acid and methacrylic acid; acrylic esters such as methyl acrylate, ethyl acrylate, propyl acrylate, butyl acrylate, 2-ethylhexyl acrylate, and dimethylaminoethyl acrylate; methacrylic esters such as methyl methacrylate, ethyl methacrylate, propyl methacrylate, butyl methacrylate, 2-ethylhexyl methacrylate, and dimethylaminoethyl methacrylate; nitryl compounds such as acrylonitrile and methacrylonitrile; amide compounds such as acrylamide and methacrylamide; and olefins such as ethylene, propylene, and butylene are conceivable.

These monovinyl monomers can be independently used or at least two types thereof can be used in combination therewith.

Among these, it is desirable to include at least one selected from a group consisting of styrene, styrene derivatives, acrylic ester and methacrylic ester as a monovinyl monomer. More desirably, at least one selected from a group consisting of styrene and butyl acrylate is included.

It is desirable that the polymerizable monomers include a monovinyl monomer as a main ingredient. Specifically, it is desirable that the content of the monovinyl monomers in the polymerizable monomers be from 50 mass % to 100 mass %.

As a polymerization initiator used in manufacture of toner particles through the polymerization method, persulfates such as potassium persulfate and ammonium persulfate; azo compounds such as 4,4′-azobis (4-cyanovaleric acid), 2,2′-azobis (2-methyl-N-(2-hydroxyethyl) propionamide), 2,2′-azobis (2-amidinopropane) dihydrochloride, 2,2′-azobis (2,4-dimethylvaleronitrile), and 2,2′-azobis isobutyronitrile; and organic peroxides such as di-t-butyl peroxide, benzoyl peroxide, t-butyl peroxy-2-ethylhexanoate, t-butyl peroxy diethyl acetate, t-hexyl peroxy-2-ethylbutanoate, diisopropyl peroxy dicarbonate, di-t-butyl peroxy isophthalate, and t-butyl peroxy diisobutylate are conceivable. These can be independently used or at least two types thereof can be used in combination therewith. Among these, it is desirable to use an organic peroxide because in this case the amount of residual polymerizable monomers can be decreased and high print durability is obtained.

Among organic peroxides, peroxy esters are desirable and non-aromatic peroxy esters, that is, peroxy-esters having no aromatic rings are more desirable because in this case initiator efficiency is high and the amount of remaining polymerizable monomers can be decreased.

Although the polymerization initiator may be added before droplet formation after the polymerizable monomer composition is dispersed in an aqueous medium, as described above, it may be added to the polymerizable monomer composition before being dispersed in the aqueous medium.

The dosage of the polymerization initiator used for polymerization of the polymerizable monomer composition is desirably from 0.1 part by mass to 20 parts by mass, further desirably from 0.3 parts by mass to 15 parts by mass, and especially desirably from 1 part by mass to 10 parts by mass with respect to 100 parts by mass of the polymerizable monomer.

When the toner particles are manufactured through the polymerization method, a crosslinking agent may be added. A desirable dosage of the crosslinking agent is from 0.001 part by mass to 15 parts by mass with respect to 100 parts by mass of the polymerizable monomer.

As the crosslinking agent, at least two polymerizable compounds having a double bond are mainly used. Specifically, for example, aromatic divinyl compounds such as divinyl benzene, divinyl naphthalene, and derivatives thereof; ester compounds in which at least two carboxylic acids having a carbon-carbon double bond are ester-bonded to an alcohol having at least two hydroxyl groups, such as ethylene glycol dimethacrylate and diethylene glycol dimethacrylate; other divinyl compounds such as N,N-divinyl aniline and divinyl ether; compounds having at least three vinyl groups, and the like can be conceivable.

These crosslinking agents can be independently used or at least two types thereof can be used in combination therewith.

The toner particles may include a colorant. When a colored toner is manufacture, colorants such as black, cyan, yellow and magenta can be used.

As a black colorant, for example, carbon black, titan black, magnetic powders such as zinc iron oxide and nickel iron oxide, and the like can be used.

As a cyan colorant, for example, copper phthalocyanine compounds, derivatives thereof, anthraquinone, and the like can be used. Specifically, C.I. Pigment Blues 2, 3, 6, 15, 15:1, 15:2, 15:3, 15:4, 16, 17:1, and 60, and the like are conceivable.

As a yellow colorant, for example, azo-based pigments such as a monoazo pigment and a disazo pigment, and a compound such as polycyclic dye can be used. Specifically, C.I. Pigment Yellows 3, 12, 13, 14, 15, 17, 62, 65, 73, 74, 83, 93, 97, 120, 138, 155, 180, 181, 185, 186, and 213, and the like are conceivable.

As a magenta colorant, for example, azo-based pigments such as a monoazo pigment and a disazo pigment, and a compound such as polycyclic dye can be used. Specifically, C.I. Pigment Reds 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255, 269 and C.I. Pigment Violet 19, and the like are conceivable.

The colorants can be independently used or at least two types thereof can be used in combination therewith. The amount of a colorant is desirably from 1 part by mass to 10 parts by mass with respect to 100 parts by mass of the polymerizable monomer.

As other additives, a positive charge type or negative charge type charge control agent can be used in order to improve the charging performance of the toner.

The charge control agents are not particularly limited as long as they are already generally used for toners. Among charge control agents, a positive charge type or negative charge type charge control resin is desirable because it has high compatibility with a polymerizable monomer and can provide stabilized charging performance (charge stability) to toner particles, and a positive charge type charge control resin is more desirably used from the viewpoint of acquisition of a positive charge type toner.

As a positive charge type charge control agent, nigrosine dyes, quaternary ammonium salts, triaminotriphenylmethane compounds, and imidazole compounds are conceivable, and examples of a charge control resin include a polyamine resin, a copolymer containing a quaternary ammonium group, a copolymer containing a quaternary ammonium salt group, and the like.

As a negative charge type charge control agent, an azo dye containing a metal such as Cr, Co, Al or Fe, a salicylic acid metal compound, an alkylsalicylate metal compound, a copolymer containing a sulfonate group as a desirably used charge control resin, a copolymer containing a sulfonic acid salt group, a copolymer containing a carboxylic acid group, a copolymer containing a carboxylic acid salt group, and the like are conceivable.

The charge control agent is used in a proportion of from 0.01 part by mass to 10 parts by mass desirably, and from 0.03 parts by mass to 8 parts by mass more desirably with respect to 100 parts by mass of the polymerizable monomer. When the dosage of the charge control agent is at least 0.01 part by mass, hardly any fogging tends to occur. On the other hand, when the dosage of the charge control agent is not more than 10 parts by mass, printing contamination tends to hardly occur.

Further, as another additive, it is desirable to use a molecular-weight adjusting agent when polymerizing polymerizable monomers which polymerize to becomes a binder resin.

Molecular-weight adjusting agents are not particularly limited if they are generally used as a molecular-weight adjusting agent for a toner. For example, mercaptans such as t-dodecylmercaptan, n-dodecylmercaptan, n-octylmercaptan, and 2,2,4,6,6-pentamethylheptane-4-thiol; thiuram disulfides such as tetramethyl thiuram disulfide, tetraethyl thiuram disulfide, tetrabutyl thiuram disulfide, N,N′-diphenyl thiuram disulfide, and N,N′-dioctadecyl-N,N′-diisopropyl thiuram disulfide; and the like are conceivable. These molecular-weight adjusting agents can be independently used or at least two types thereof can be used in combination therewith.

A molecular-weight adjusting agent is used in a proportion of from 0.01 part by mass to 10 parts by mass desirably and from 0.1 part by mass to 5 parts by mass with respect to 100 parts by mass of the polymerizable monomer.

In a method of manufacturing toner particles through the polymerization method, a polymerizable monomer composition in which the raw materials of the aforementioned toner particles are appropriately added and uniformly dissolved or dispersed using a disperser such as a homogenizer, a ball mill, or an ultrasonic disperser is suspended in an aqueous medium containing a dispersing agent, in general. Here, when a desired toner particle size is instantly obtained using a high-speed agitator or a high-speed disperser such as an ultrasonic disperser, the particle diameter distribution of the acquired toner particles becomes sharp.

With respect to a timing at which the polymerization initiator is added, the polymerization initiator may be added simultaneously with addition of other additives to the polymerizable monomers or it may be incorporated immediately before suspension in the aqueous medium. In addition, the polymerization initiator dissolved in the polymerizable monomers or a solvent can be added before the polymerization reaction starts immediately after granulation.

After granulation, it is desirable to perform agitation to a degree to which a particle state is maintained and floating and precipitation of particles are prevented using a conventional agitator.

When toner particles are manufactured, a known surfactant, organic dispersing agent or an inorganic dispersing agent can be used as a dispersing agent. Among these, an inorganic dispersing agent is desirably used because in this case dispersion stability is acquired according to the steric hindrance thereof and thus the stability is unlikely to collapse even when a reaction temperature is changed, and cleaning is also easy since it is unlikely that it will exert an adverse influence on the toner. As examples of this inorganic dispersing agent, sulfates such as barium sulfate and calcium sulfate; carbonates such as barium carbonate, calcium carbonate, and magnesium carbonate; phosphate such as calcium phosphate; metal oxides such as aluminum oxide and titanium oxide; metal hydroxides such as aluminum hydroxide, magnesium hydroxide, and ferric hydroxide; and the like are conceivable.

It is desirable to use these inorganic dispersing agents in amount of from 0.2 parts by mass to 20 parts by mass with respect to 100 parts by mass of the polymerizable monomer. In addition, the aforementioned dispersing agents can be independently used or a plurality of types thereof can be used in combination therewith. Further, from 0.001 part by mass to 0.1 part by mass of a surfactant may be used in combination therewith.

In a process of polymerizing the aforementioned polymerizable monomer, a polymerization temperature is desirably at least 50° C. and further desirably from 60° C. to 95° C. In addition, a polymerization reaction time is desirably from 1 hour to 20 hours and further desirably from 2 hours to 15 hours.

Although polymer particles including a wax acquired through the aforementioned polymerization reaction may be used as polymerized toner particles as they are, it is desirable to acquire so-called core shell type (or also referred to as “capsule type”) polymer particles by using the polymer particles as a core layer and forming a shell layer different from the core layer on the outer side of the core layer. The core shell type polymer particles can balance reduction in a fixing temperature and aggregation prevention during storage by covering the core layer composed of a material having a low softening point with a material having a softening point higher than this low softening point.

The above-described method of manufacturing the core shell type polymer particles using the aforementioned polymer particles is not particularly limited and the core shell type polymer particles can be manufactured through conventional known methods. Among them, an in situ polymerization method and the phase separation method are desirable in terms of manufacturing efficiency.

A method of manufacturing the core shell type polymer particles through an in situ polymerization method will be described below.

The core shell type polymer particles can be acquired by adding a polymerizable monomer (polymerizable monomer for a shell) for forming the shell layer and a polymerization initiator to an aqueous medium in which polymer particles are dispersed and performing polymerization.

As the polymerizable monomer for the shell, the same aforementioned polymerizable monomers can be used. Among them, desirably, monomers from which a polymer having a glass transition temperature (Tg) exceeding 80° C. is acquired, such as styrene, acrylonitrile and methyl methacrylate, are used independently or at least two types thereof are used in combination therewith. Among them, it is desirable to use at least methyl methacrylate as the polymerizable monomer for the shell.

As a polymerization initiator used for polymerization of the polymerizable monomer for the shell, water-soluble polymerization initiators such as: persulfate metal salts such as potassium persulfate and ammonium persulfate; and azo initiators such as 2,2′-azobis(2-methyl-N-(2-hydroxyethyl)propionamide), 2,2′-azobis-(2-methyl-N-(1,1′-bis(hydroxymethyl) 2-hydroxyethyl)propionamide), 2,2′-azobis[N-(2-carboxyethyl)-2-methyl propionamidine] and hydrates thereof are conceivable. These can be independently used or at least two types thereof can be used in combination therewith. The amount of a polymerization initiator is desirably from 0.1 part by mass to 30 parts by mass and more desirably from 1 part by mass to 20 parts by mass with respect to 100 parts by mass of the polymerizable monomer for the shell.

When the phase separation method is used, it is desirable to add a polymer obtained by polymerizing a material forming a shell in advance to a polymerizable monomer for forming a core. When the polymer polymerized in advance is used, it is more desirable that the polymer be a reactive polymer having an unsaturated bond.

A polymerization temperature of the shell layer is desirably at least 50° C. and further desirably from 60° C. to 95° C. In addition, a polymerization reaction time is desirably from 1 hour to 20 hours and further desirably from 2 hours to 15 hours.

Toner particles can be acquired by performing percolation, washing and drying on the acquired polymer particles through known methods as necessary. In addition, it is also possible to remove coarse powder and fine powder included in the toner particles by adding a classification process as necessary.

The acquired toner particles can be used as a toner as they are. In addition, it is possible to acquire a toner by mixing an external additive with the toner particles as necessary to attach an external additive to the surface of the toner particles.

An agitator used to perform mixing processing is not particularly limited if it can attach an external additive to the surface of the toner particles, and external addition processing can be performed using an agitator capable of performing mixing agitation, such as an FM Mixer (product name, manufactured by Nippon Coke & Engineering Co., Ltd.), a Super Mixer (product name, manufactured by Kawata Mfg. Co., Ltd.), Q Mixer (product name, manufactured by Nippon Coke & Engineering Co., Ltd.), Mechano Fusion System (product name, manufactured by Hosokawa Micron Corporation) or Mechanomill (product name, manufactured by Okada Seiko Co., Ltd.), for example.

As an external additive, inorganic fine particles such as silica, titanium oxide, aluminum oxide, zinc oxide, tin oxide, calcium carbonate, calcium phosphate, and cerium oxide; organic fine particles such as polymethylmethacrylate resins, silicone resin and melamine resins; and the like are conceivable. Among these, inorganic fine particles are desirable, and among inorganic fine particles, silica and titanium oxide are desirable and silica is more desirable.

Meanwhile, although these external additives can be independently used, at least two types thereof can be used in combination therewith.

The content of external additives is desirably from 0.05 parts by mass to 6 parts by mass and desirably from 0.2 parts by mass to 5 parts by mass with respect to 100 parts by mass of the toner particles.

A melting temperature (Tm) of the toner through the 1/2 method in a flow tester is desirably from 100° C. to 150° C. and more desirably from 120° C. to 140° C. When Tm of the toner is within the aforementioned range, low-temperature fixability and hot-offset resistance become easily compatible.

Tm can be controlled by a polymerization temperature, a dosage of a crosslinking agent, and the like.

The glass transition temperature (Tg) of the toner is desirably from 44° C. to 60° C. and more desirably from 50° C. to 58° C.

The number average molecular weight (Mn) of the toner is desirably from 5,000 to 20,000 and more desirably from 7,000 to 15,000. The low-temperature fixability tends to increase when the number average molecular weight is not more than 20,000 and the heat resistant storage stability tends to increase when the number average molecular weight is at least 5,000.

The weight average molecular weight (Mw) of the toner is desirably from 100,000 to 300,000 and more desirably from 150,000 to 280,000. The low-temperature fixability tends to increase when the weight average molecular weight is equal to or less than 300,000 and heat resistant storage stability tends to increase when the weight average molecular weight is at least 100,000.

The molecular weight dispersity (Mw/Mn) of the toner is desirably from 10 to 40 and more desirably from 15 to 35. The low-temperature fixability and storage stability tend to increase when the molecular weight dispersity is not more than 40 and hot-offset resistance tends to increase when the molecular weight dispersity is at least 10.

Mn and Mw of the toner can be controlled by a polymerization temperature, a dosage of a crosslinking agent, and the like.

Next, a photosensitive member will be described in detail.

### Electrophotographic Photosensitive Member

The photosensitive member comprises a surface layer having a binder resin (A). The binder resin (A) comprises a structure represented by the following formula (1).

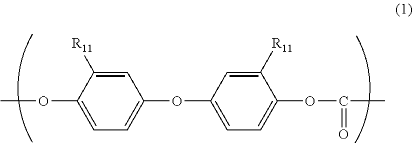

In formula (1), each R₁₁ independently represents a hydrogen atom or a methyl group.

Although the content of the structure represented by the above formula (1) in the binder resin (A) is not particularly limited, at least 10 mass % is desirable. The content is desirably not more than 100 mass % and more desirably not more than 60 mass %. The numerical value ranges can be arbitrarily combined.

In addition, although the content of the structure represented by the above formula (1) is not particularly limited, it is desirably at least 20 mol % desirably at least 25 mol % on the basis of a total number of moles of all monomer units in the binder resin (A). The content ratio is desirably not more than 100 mol %, more desirably not more than 50 mol % and further desirably not more than 40 mol %. The numerical value ranges can be arbitrarily combined.

In addition, it is desirable that the binder resin (A) further comprise a structure represented by the following formula (4).

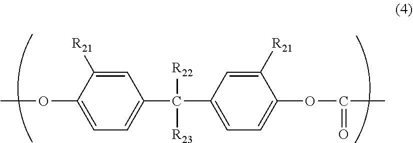

In formula (4), R₂₁'s independently represent a hydrogen atom or a methyl group and R₂₂ and R₂₃ independently represent hydrogen atoms, methyl groups, ethyl groups or phenyl groups, or R₂₂ and R₂₃ are linked to each other to form a cycloalkylidene group.

It is desirable that, in the binder resin (A), the molar ratio of the structure represented by the above formula (1) to the structure represented by the above formula (4) is satisfies following formula:

the structure represented by formula (1):the structure represented by formula (4)=5:95 to 95:5.

A lower limit of the molar ratio is more desirably at least 10:90, at least 15:85, at least 20:80, at least 25:75, at least 30:70, at least 35:65, at least 40:60, or at least 45:55.

An upper limit of the molar ratio is more desirably not more than 90:10, not more than 85:15, not more than 80:20, not more than 75:25, not more than 70:30, not more than 65:35, not more than 60:40, not more than 55:45, or not more than 50:50.

The aforementioned numerical value ranges can be arbitrarily combined.

In addition, it is desirable that R₂₂ be a methyl group and R₂₃ be an ethyl group in the above formula (4).

The weight average molecular weight (Mw) of the binder resin (A) is desirably within a range of from 10,000 to 300,000 and more desirably within a range of from 20,000 to 200,000. Mw can be controlled by polymerization conditions such as a combination ratio between monomers and a reaction temperature.

A method of manufacturing the binder resin (A) is not particularly limited if it can manufacture a resin having the structure represented by the above formula (1) (and the structure represented by the above formula (4) as necessary). As the manufacturing method, for example, a method of interfacial-polycondensing a diol compound and phosgene for manufacturing the structure represented by the above formula (1) and a diol compound for constituting the structure represented by the above formula (4) as necessary, a method of transesterifying the diol compound and diphenyl carbonate, and the like are conceivable.

More specifically, a method of interfacial-polycondensing a diol compound represented by formula (1′) described below (and a diol compound represented by formula (4′) described below as necessary) and phosgene is conceivable, for example.

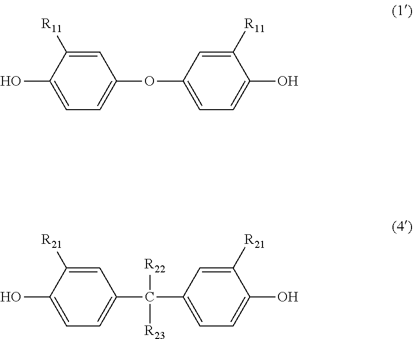

In formula (1′), R₁₁'s independently represent a hydrogen atom or a methyl group.

In formula (4′), R₂₁'s independently represent a hydrogen atom or a methyl group. R₂₂ and R₂₃ independently represent hydrogen atoms, methyl groups, ethyl groups or phenyl groups, or R₂₂, R₂₃ and C between R₂₂ and R₂₃ represented in formula (4′) are linked to form a cycloalkylidene group.

As an example of a method of manufacturing a photosensitive member, a method of preparing a coating solution of each layer, coating the coating solutions on a support in order of desired layers and drying the coating solutions, which will be described layer, is conceivable. Here, as a method of coating the coating solutions, immersion coating, spray coating, ink jet coating, roll coating, die coating, blade coating, curtain coating, wire bar coating, ring coating, and the like are conceivable. Among these, immersion coating is desirable in terms of efficiency and productivity.

Hereinafter, each layer will be described.

Support

The photosensitive member can have a support. It is desirable that the support be a conductive support having conductivity. In addition, a cylindrical shape, a belt shape, a sheet shape and the like are conceivable as a shape of the support. Among them, a cylindrical support is desirable. In addition, an electrochemical treatment such as anodization, blasting, a cutting treatment, and the like may be performed on the surface of the support.

As a material of the support, a metal, a resin, a glass, or the like are desirable.

As the metal, aluminum, iron, nickel, copper, gold, stainless steel, and alloys thereof, or the like are conceivable. Among them, an aluminum support using aluminum is desirable.

In addition, the resin and glass may be imparted with conductivity through a treatment such as incorporation of, or covering with or the like a conductive material.

Conductive Layer

A conductive layer may be provided on the support. It is possible to mask damage or unevenness on the surface of the support and control reflection of light at the surface of the support by providing a conductive layer.

It is desirable that the conductive layer contain conductive particles and a resin.

As a material of the conductive particles, metal oxides, a metal, carbon black, or the like are conceivable.

Regarding a metal oxide, zinc oxide, aluminum oxide, indium oxide, silicon oxide, zirconium oxide, tin oxide, titanium oxide, magnesium oxide, antimony oxide, bismuth oxide, or the like is conceivable.

As the metal, aluminum, nickel, iron, nichrome, copper, zinc, silver, or the like is conceivable.

Among these, it is desirable to use the metal oxide, particularly, it is more desirable to use titanium oxide, tin oxide or zinc oxide as the material of the conductive particles.

When the metal oxide is used as the material of the conductive particles, the surface of the metal oxide particles may be processed with a silane coupling agent or the like, or the metal oxide may be doped with an element such as phosphorus or aluminum or oxides thereof.

In addition, the conductive particles may have a laminate configuration having core particles and a covering layer covering the particles. Titanium oxide, barium sulfate, zinc oxide, or the like is conceivable as a material of the core particles. A metal oxide such as tin oxide is conceivable as a material of the covering layer.

In addition, when the metal oxide particles are used as the conductive particles, the volume average particle diameter thereof is desirably from 1 nm to 500 nm and more desirably from 3 nm to 400 nm.

As a resin, polyester resin, polycarbonate resin, polyvinylacetal resin, acrylic resin, silicone resins, epoxy resin, melamine resin, polyurethane resin, phenol resin, alkyd resin, or the like is conceivable.

In addition, the conductive layer may further contain a masking agent such as silicone oil, resin particles, and titanium oxide.

The average film thickness of the conductive layer is desirably from 1 μm to 50 μm and especially desirably from 3 μm to 40 μm.

The conductive layer can be formed by preparing a coating solution for the conductive layer which contains the above-described materials and a solvent, forming a coating film thereof, and drying the coating film. As a solvent used for the coating solution, an alcohol solvent, a sulfoxide-based solvent, a ketone solvent, an ether solvent, an ester solvent, an aromatic hydrocarbon solvent, or the like is conceivable. As a dispersion method for dispersing the conductive particles in the coating solution for the conductive layer, methods using a paint shaker, a sand mill, a ball mill, and a liquid collision type high-speed disperser are conceivable.

Undercoating Layer

An undercoating layer may be provided on the support or the conductive layer. It is possible to improve an inter-layer adhesion function and provide a charge injection blocking function by providing an undercoating layer.

It is desirable that the undercoating layer contain a resin. In addition, the undercoating layer may be formed as a cured film by polymerizing a composition containing a monomer having a polymerizable functional group.

As the resin, polyester resin, polycarbonate resin, polyvinyl acetal resin, acrylic resin, epoxy resin, melamine resin, polyurethane resin, phenol resin, polyvinyl phenol resin, alkyd resin, polyvinyl alcohol resin, polyethylene oxide resin, polypropylene oxide resin, polyamide resin, polyamic acid resin, polyimide resin, polyamideimide resin, cellulosic resin, or the like is conceivable.

As the polymerizable functional group in the monomer having a polymerizable functional group, an isocyanate group, a blocked isocyanate group, a methylol group, an alkylate methylol group, an epoxy group, a metal alkoxide group, a hydroxyl group, an amino group, a carboxyl group, a thiol group, a carboxylic acid anhydride group, a carbon-carbon double bond group, or the like is conceivable.

In addition, the undercoating layer may further contain an electron transport material, a metal oxide, a metal, an electroconductive polymer, and the like for the purpose of enhancing electrical properties. Among these, it is desirable to include an electron transport material and a metal oxide.

As the electron transport material, a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, a boron-containing compound, or the like is conceivable. The undercoating layer may be formed as a cured film by using an electron transport material having a polymerizable functional group as the electron transport material and copolymerizing it with the aforementioned monomer having a polymerizable functional group.

As the metal oxide, indium tin oxide, tin oxide, indium oxide, titanium oxide, zinc oxide, aluminum oxide, silicon dioxide, or the like is conceivable. As the metal, gold, silver, aluminum, or the like is conceivable.

In addition, the undercoating layer may further contain an additive.

The average film thickness of the undercoating layer is desirably from 0.1 μm to 50 μm, more desirably from 0.2 μm to 40 μm, and especially desirable from 0.3 μm to 30 μm.

The undercoating layer can be formed by preparing a coating solution for the undercoating layer containing the aforementioned materials and a solvent, forming a coating film thereof, and drying and/or curing the coating film. As the solvent used for the coating solution, an alcohol solvent, a ketone solvent, an ether solvent, an ester solvent, an aromatic hydrocarbon solvent, or the like is conceivable.

Photosensitive Layer

The photosensitive member can include a photosensitive layer, in general. It is desirable that the photosensitive layer be formed on the support, and the conductive layer and the undercoating layer may be provided between the support and the photosensitive layer. These photosensitive layers are mainly classified into (1) a single layer type photosensitive layer and (2) a laminate type photosensitive layer.

(1) The single layer type photosensitive layer can have a photosensitive layer containing both a charge generation material, a charge transport material and an electron transport material, for example.

(2) The laminate type photosensitive layer can have a charge generation layer containing a charge generation material and a charge transport layer containing a charge transport material, for example.

(1) Single Layer Type Photosensitive Layer

A single layer type photosensitive layer can be used as the photosensitive layer. The single layer type photosensitive layer can be formed, for example, by preparing a coating solution for the photosensitive layer containing a charge generation material, a charge transport material, an electron transport material, a resin, and a solvent, forming a coating film thereof, and drying the coating film. When the single layer type photosensitive layer is the surface layer of the photosensitive member, the resin contains the binder resin (A).

When the single layer type photosensitive layer is the surface layer of the photosensitive member, the single layer type photosensitive layer may contain resins other than the binder resin (A) in a range in which the effects of the present disclosure are not damaged. As other resins, for example, polycarbonate resin, styrene resin, acrylic resin, and the like are conceivable.

As the charge generation material, azo pigments, perylene pigments, polycyclic quinone pigments, indigo pigments, phthalocyanine pigments, or the like are conceivable. Among these, the azo pigments and the phthalocyanine pigments are desirable. Among the phthalocyanine pigments, metal-free phthalocyanine, oxytitanium phthalocyanine pigments, chlorogallium phthalocyanine pigments, and hydroxygallium phthalocyanine pigments are desirable.

As the charge transport material, for example, a polycyclic aromatic compound, a heterocyclic compound, a hydrazone compound, styryl compounds, an enamine compound, a benzidine compound, a triaryamine compound, a resin having a group derived from these materials, or the like is conceivable. These charge transport materials can be independently used or at least two types thereof can be used in combination therewith. Among these, the triarylamine compound and the benzidine compound are desirable.

As the electron transport material, for example, a quinone-based compound, a diimide compound, a hydrazine-based compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromo maleic anhydride are conceivable.

As the quinone-based compound, for example, a diphenoquinone-based compound, an azoquinone-based compound, an anthraquinone-based compound, a naphthoquinone-based compound, a nitroanthraquinone-based compound, and a dinitroanthraquinone-based compound are conceivable.

These electron transport materials can be independently used or at least two types thereof can be used in combination therewith.

Among these electron transport materials, compounds represented by formulas (5) to (13) below are desirable.

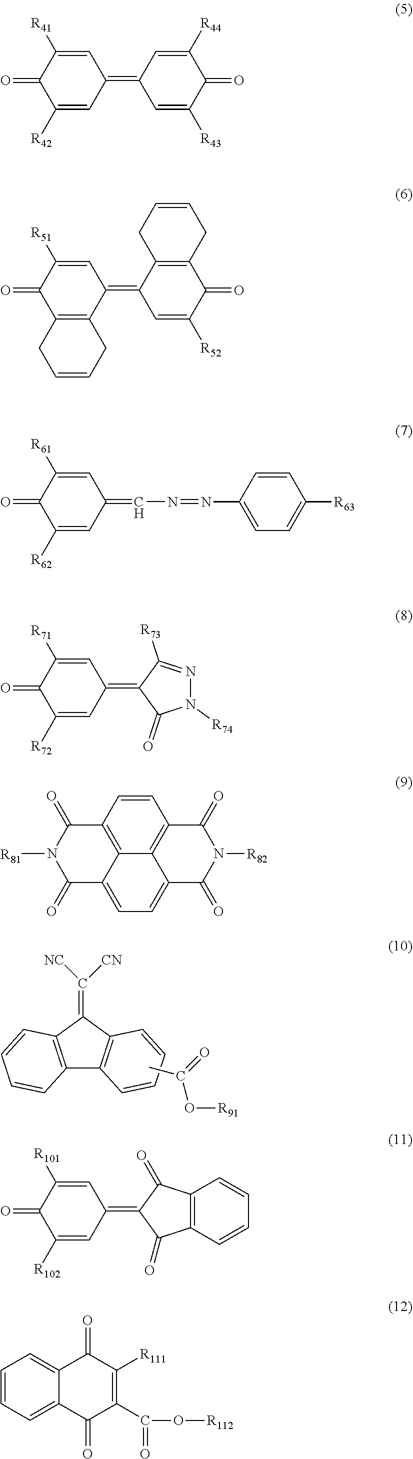

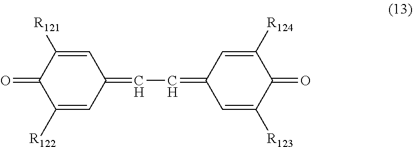

In formulas (5) to (13),

R₄₁ to R₄₄, R₅₁, R₅₂, R₆₁, R₆₂, R₇₁ to R₇₃, R₁₀₁, R₁₀₂, R₁₂₁ to R₁₂₄ independently represent hydrogen atoms or alkyl groups having a number of carbon atoms of from 1 to 6 (desirably from 1 to 4),

R₆₃ represents a hydrogen atom, a halogen group or an alkyl group having a number of carbon atoms of from 1 to 6 (desirably from 1 to 4),

R₇₄, R₈₁ and R₈₂ independently represent alkyl groups having a number of carbon atoms of from 1 to 6 (desirably from 1 to 4), halogen groups or phenyl groups which may have an alkyl group having a number of carbon atoms of from 1 to 6 (desirably from 1 to 4),

R₉₁ represents an alkyl group having a number of carbon atoms of from 1 to 6 (desirably from 1 to 4) which may have a hydrogen atom or a halogen atom, and

R₁₁₁ and R₁₁₂ represent alkyl groups having a number of carbon atoms of from 1 to 6 (desirably from 1 to 4) which may have a substituent, or phenyl groups which may have a substituent.

Table 1 shows specific examples of charge transport materials represented by formulas (5) to (13).

TABLE 1

| | |
|---|---|
| 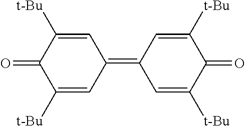 [SMILES: CC(C)(C)C1=CC(=C2C=C(C(C)(C)C)C(=O)C(C(C)(C)C)=C2)C=C(C(C)(C)C)C1=O] | E4-1 |
| 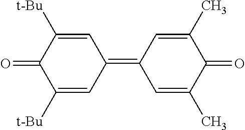 [SMILES: CC1=CC(=C2C=C(C(C)(C)C)C(=O)C(C(C)(C)C)=C2)C=C(C)C1=O] | E4-2 |
| 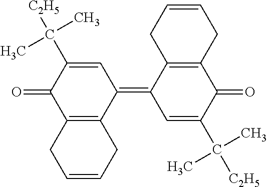 [SMILES: CCC(C)(C)C1=C/C(=C2/C=C(C(C)(C)CC)C(=O)C3=C2CC=CC3)C2=C(CC=CC2)C1=O] | E5-1 |
| 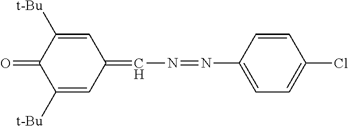 [SMILES: CC(C)(C)C1=CC(=CN=Nc2ccc(Cl)cc2)C=C(C(C)(C)C)C1=O] | E6-1 |
| 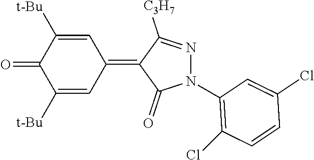 | E7-1 |
| 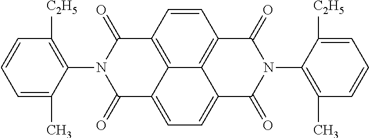 [SMILES: CCc1cccc(C)c1N1C(=O)c2ccc3c4c(ccc(c24)C1=O)C(=O)N(c1c(C)cccc1CC)C3=O] | E8-1 |
| 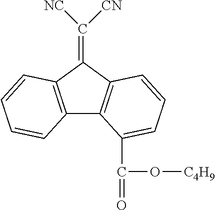 | E9-1 |
| 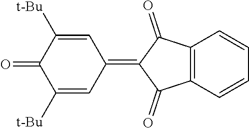 [SMILES: CC(C)(C)C1=CC(=C2C(=O)c3ccccc3C2=O)C=C(C(C)(C)C)C1=O] | E10-1 |
| 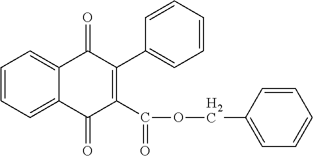 [SMILES: O=C(OCc1ccccc1)C1=C(c2ccccc2)C(=O)c2ccccc2C1=O] | E11-1 |
| 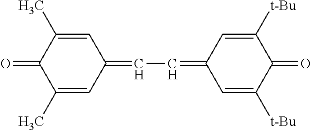 [SMILES: CC1=CC(=CC=C2C=C(C(C)(C)C)C(=O)C(C(C)(C)C)=C2)C=C(C)C1=O] | E12-1 |

In Table 1, t-Bu represents a t-butyl group.

A content ratio (mass ratio) of the charge generation material to all resin components in the photosensitive layer is desirably from 1:1000 to 50:100 and more desirably from 5:1000 to 30:100.

A content ratio (mass ratio) of the charge transport material to the all resin components in the photosensitive layer is desirably from 1:10 to 20:10 and more desirably from 1:10 to 10:10.

A content ratio (mass ratio) of the electron transport material to the all resin components in the photosensitive layer is desirably from 5:100 to 10:10 and more desirably from 1:10 to 8:10.

In addition, the photosensitive layer may contain additives such as an antioxidant, an ultraviolet absorber, a plasticizing agent, a leveling agent, a slipperiness providing agent, and an abrasion resistance improver. Specifically, a hindered phenol compound, a hindered amine compound, a sulfur compound, a phosphorus compound, a benzophenone compound, a siloxane modified resin, silicone oil, fluororesin particles, polystyrene resin particles, polyethylene resin particles, silica particles, alumina particles, boron nitride particles, and the like are conceivable.

Among them, the silica particles may be added in order to improve the durability of the photosensitive layer.

Surface treatment may be performed on the silica particles using a surface treatment agent. As the surface treatment agent, for example, hexamethyldisilazane, N-methyl-hexamethyldisilazane, hexamethyl-N-propyl disilazane, dimethyldichlorosilane, or polydimethylsiloxane is conceivable. The hexamethyldisilazane is especially desirable as the surface treatment agent.

The content of the silica particles is desirably from 0.5 parts by mass to 15 parts by mass with respect to 100 parts by mass of the binder resin (A).

The content of the silica particles is desirably from 0.5 parts by mass to 15 parts by mass and more desirably from 1 part by mass to 10 parts by mass with respect to 100 parts by mass of all resin components in the photosensitive layer.

The volume average particle diameter of the silica particles is desirably from 7 nm to 1000 nm and more desirably from 10 nm to 300 nm. Meanwhile, the specification and volume average particle diameter of the silica particles can be checked through cross-sectional observation of the photosensitive layer using the scanning electron microscope (SEM) or the like.

The average film thickness of the photosensitive layer is desirably from 5 μm to 100 μm and more desirably from 10 μm to 50 μm.

The photosensitive layer can be formed by preparing a coating solution for the photosensitive layer containing the aforementioned materials and a solvent, forming a coating film thereof, and drying the coating film. As the solvent used for the coating solution, an alcohols solvent, a ketones solvent, an ether solvent, an ester solvent, or an aromatic hydrocarbon solvent is conceivable. Among these solvents, the ether solvent or the aromatic hydrocarbon solvent are desirable.

(2) Laminate Type Photosensitive Layer

The photosensitive layer may be a laminate type photosensitive layer. The laminate type photosensitive layer can have a charge generation layer and a charge transport layer, for example.

The charge generation layer may contain a charge generation material and a resin.

The charge transport layer may contain a charge transport material and a resin. When the laminate type photosensitive layer is the surface layer of the photosensitive member, the charge transport layer contains the binder resin (A).

As the charge generation material, the charge transport material and the resin, the same materials as those exemplified in the aforementioned “(1) Single Layer Type Photosensitive Layer” can be used.

The content of the charge generation material in the charge generation layer is desirably from 40 mass % to 85 mass % and more desirably from 60 mass % to 80 mass % with respect to the total mass of the charge generation layer.

The average film thickness of the charge generation layer is desirably from 0.1 μm to 1 μm and more desirably from 0.15 μm to 0.4 μm.

The content of the charge transport material in the charge transport layer is desirably from 25 mass % to 70 mass % and more desirably from 30 mass % to 55 mass % with respect to the total mass of the charge transport layer.

A content ratio (mass ratio) of the charge transport material to the resin is desirably from 4:10 to 20:10 and more desirably from 5:10 to 12:10.

In addition, the same additives as those exemplified in the aforementioned “(1) Single Layer Type Photosensitive Layer” may be contained.

The average film thickness of the charge transport layer is desirably from 5 μm to 50 μm, more desirably from 8 μm to 40 μm, and especially desirably from 10 μm to 30 μm.

When the value of the polarity term based on the Hansen solubility parameter of the structure represented by the above formula (1) is defined as δp(A) ((J/cm³)^{0.5}), it is desirable that the δp(A) and the δp(w) are satisfy the following formula.

5.8≤δp(A)−δp(w)≤6.5

When the value of δp(A)−δp(w) is not more than 6.5, a polarity difference therebetween decreases and attachment force reduction effect is easily acquired. On the other hand, when the value of δp(A)−δp(w) is at least 5.8, the solubility of the binder resin (A) with respect to the solvent tends to hardly decrease and physical properties such as abrasion resistance are difficult to decrease.

δp(A)−δp(w) is from 5.9 to 6.4 more desirably. In addition, δp(A) is desirably from 4.0 to 10.0 and more desirably from 5.0 to 9.0. δp(A) can be controlled by changing the type, content and the like of a monomer that is a raw material of a compound included in the binder resin (A), and the like.

Process Cartridge and Image Forming Apparatus

A process cartridge of the present disclosure comprises:

an electrophotographic photosensitive member; and

a developing device comprising a toner, the developing device being for supplying the toner to the electrophotographic photosensitive member, wherein

the electrophotographic photosensitive member comprises a surface layer comprising the aforementioned binder resin (A),

the toner is the aforementioned toner, and

the process cartridge is attached detachably to a main body of an image forming apparatus.

The process cartridge may comprise at least one selected from a group consisting of a charging device, an image forming device, a transfer device and cleaning device as necessary.

In addition, an image forming apparatus of the present disclosure comprises:

an electrophotographic photosensitive member; and

a developing device comprising a toner, the developing device being for supplying the toner to the electrophotographic photosensitive member, wherein

the electrophotographic photosensitive member comprises a surface layer comprising the aforementioned binder resin (A), and

the toner comprises the aforementioned toner particle.

The image forming apparatus may comprise at least one selected from a group consisting of a charging device, an image forming device, a transfer device, a cleaning device, and an exposure device as necessary.

The FIGURE shows an example of a schematic configuration of an image forming apparatus having a process cartridge including an electrophotographic photosensitive member.

1 is a cylindrical electrophotographic photosensitive member which rotates on a shaft 2 at a predetermined circumferential speed in a direction indicated by an arrow. The surface of the electrophotographic photosensitive member 1 is charged to a predetermined positive or negative potential through a charging means 3. Meanwhile, although the FIGURE illustrates a roller charging system using a roller type charging member, charging systems such as a corona charging system, a proximity charging system, and an injection charging system may be employed.

Exposure light 4 is radiated from an exposure means (not shown) to the charged surface of the electrophotographic photosensitive member 1 and thus an electrostatic latent image corresponding to target image information is formed. The electrostatic latent image formed on the surface of the electrophotographic photosensitive member 1 is developed using a toner contained in a developing means 5 and thus a toner image is formed on the surface of the electrophotographic photosensitive member 1. The toner image formed on the surface of the electrophotographic photosensitive member 1 is transferred to a transfer material 7 through a transfer means 6. The transfer material 7 to which the toner image has been transferred is conveyed to a fixing means 8, subjected to toner image fixing processing and then printed out of the image forming apparatus.

The image forming apparatus may include a cleaning means 9 for removing deposit such as a toner remaining on the surface of the electrophotographic photosensitive member 1 after transfer. In addition, so-called a cleanerless system which removes the deposit through a developing means or the like without providing a cleaning means may be used. The image forming apparatus may include a static elimination mechanism which performs static elimination processing on the surface of the electrophotographic photosensitive member 1 using pre-exposure light 10 from a pre-exposure means (not shown). In addition, a guide means 12 such as a rail may be provided in order to attach/detach the process cartridge to/from the main body of the image forming apparatus.

The electrophotographic photosensitive member can be used for a laser beam printer, an LED printer, a copying machine, facsimile, a multifunction machine thereof, and the like.

Cartridge Set

A cartridge set of the present disclosure has the following aspect.

A cartridge set comprising a first cartridge and a second cartridge attached detachably to a main body of an image forming apparatus, wherein

the first cartridge comprises an electrophotographic photosensitive member,

the second cartridge comprises a toner container comprising a toner for developing an electrostatic latent image formed on a surface of the electrophotographic photosensitive member to form a toner image on the surface of the electrophotographic photosensitive member,

the electrophotographic photosensitive member comprises a surface layer comprising the aforementioned binder resin (A), and the toner has the aforementioned toner particle.

The first cartridge may comprise a charging device for charging the surface of the electrophotographic photosensitive member. In addition, the first cartridge may comprise a first frame body for supporting the electrophotographic photosensitive member (and the charging device as necessary).

The first cartridge or the second cartridge may comprise a developing device for forming a toner image on the surface of the electrophotographic photosensitive member. The developing device may be fixed to the main body of the image forming apparatus.

Image Forming Method

An image forming method of the present disclosure has the following aspect.

An image forming method in which an electrophotographic photosensitive member and a toner are used,

the method comprising a developing process of supplying the toner to the electrophotographic photosensitive member, wherein

the electrophotographic photosensitive member comprises a surface layer comprising the aforementioned binder resin (A), and

the toner comprises the aforementioned toner particle.

The image forming method may comprise at least one selected from a group consisting of a charging process, an image forming process, a transfer process, a cleaning process, and an exposure process as necessary.

Next, a method of measuring each physical property pertaining to the present disclosure will be described.

### Method of Measuring Melting Temperature (Tm) of Toner Through 1/2 Method

The melting temperature (Tm) of a toner through 1/2 method is measured using a capillary rheometer “flow characteristic evaluation equipment Flowtester CFT-500D” of a constant load extrusion system (manufactured by Shimadzu Corporation).

The CFT-500D is an apparatus which melts a measurement sample filled in a cylinder while increasing the temperature and extrudes the measurement sample from capillary holes of the bottom of the cylinder while applying a constant load from above through a piston to obtain a flow curve in the form of a graph from the amount of descend (mm) of the piston and the temperature (° C.) at this time.

Meanwhile, the melting temperature in the 1/2 method is calculated as follows.

First, 1/2 of a difference between an amount of descend of the piston at a point in time at which outflow ends (referred to as an outflow end point Smax) and an amount of descend of the piston at a point in time at which outflow starts (referred to as a lowest point Smin) is obtained (this is referred to as X; X=(Smax−Smin)/2). Then, a temperature of the flow curve when the amount of descend of the piston becomes the sum of X and Smin is set to a melting temperature in the 1/2 method.

As the measurement sample, a sample obtained by compressively molding 1.2 g of the toner for 60 seconds at 10 MPa in an environment of 25° C. using a tablet molding compressor (standard manual type Newton Press NT-100H, manufactured by NPa System Co., Ltd.) into a cylindrical shape with a diameter of 8 mm is used.

Specific operation in measurement is performed according to the manual of the apparatus.

Measurement conditions of CFT-500D are as follows.

Test mode: temperature increasing method
Start temperature: 40° C.
Arrival temperature: 200° C.
Measurement interval: 1.0° C.
Temperature increase rate: 3.0° C./min
Piston cross sectional area: 1.000 cm²
Test load (piston load): 10.0 kgf
Preheating time: 5 minutes
Diameter of hole of die: 0.5 mm

### Length of die: 1.0 mm

Shear stress: 2.451×10⁵ Pa

Method of Measuring Glass Transition Temperature of Toner

The glass transition temperature of the toner is measured in conformity to ASTM D 3418-97.

Specifically, 10 mg of the toner acquired through drying is precisely weighed and put into an aluminum pan. An empty aluminum pan is used as a reference. The glass transition temperature of the precisely weighed toner is measured under conditions of a measurement temperature range of from 0° C. to 150° C. and a temperature increase rate of 10° C./min in conformity to ASTM D3418-97 using a differential scanning calorimeter (manufactured by SII NanoTechnology Inc., product name: DSC6220).

Method of Measuring Molecular Weights of Toner and Resin

Number average molecular weights (Mn), weight average molecular weights (Mw) and molecular weight dispersities (Mw/Mn) of a toner and a resin are measured using gel permeation chromatography (GPC) using tetrahydrofuran (THF) as follows.

### (a) Preparation of Measurement Sample

10 mg of a sample is dissolved in 5 mL of tetrahydrofuran, leaves at 25° C. for 16 hours, and then is made into a sample through 0.45 μm membrane filter (Maishori Disc H-25-2 manufactured by Tosoh Corporation).

### (b) Measurement Conditions

Measurement equipment: LC-GPC 150C manufactured by Waters Corporation, column temperature: 35° C., solvent: tetrahydrofuran, flow rate: 1.0 mL/min, sample concentration: 0.2 mass %, sample injection amount: 100 μL (c) Column

GPC TSKgel MultiporeHXL-M (30 cm×2) manufactured by Tosoh Corporation is used. Measurement is performed in a condition in which a first-order correlation equation of weight average molecular weight Mw=Log(Mw) of from 1,000 to 300,000−dissolution time becomes at least 0.98.

Method of Measuring Melting Point of Wax

From 6 mg to 8 mg of a wax is weighed on a sample holder and measurement is performed using the differential scanning calorimetric analyzer (manufactured by Seiko Instruments Inc., product name: RDC-220) in a condition in which temperature increases at 100° C./min from −200° C. to 1,000° C. to obtain a DSC curve. A peak temperature of endothermic peaks of the DSC curve is set to a melting point.

Method of Measuring Acid Value of Wax

The acid value of the wax is measured in conformity of JIS K 0070 that is a standard oils and fats analysis technique established by Japanese Industrial Standards Committee (JISC).

Specifically, the acid value is obtained through the following method.

1) From 0.5 g to 2.0 g of wax is precisely weighed. The mass at this time is referred to as M (g).

2) The wax is put into a 50 mL beaker, 25 mL of a mixed solution of tetrahydrofuran/ethanol (2/1) is added thereto and the wax is dissolved.

3) Titration is performed using ethanol solution of 0.1 mol/L KOH through potential difference titrator (automatic titrator “COM-2500” manufactured by Hiranuma Sangyo Co., Ltd.).

4) The amount of KOH used at this time is referred to as S (mL).

Simultaneously, blank is measured and the amount of KOH solution used at this time is referred to as B (mL).

5) The acid value is calculated through the following expression. f is the factor of the KOH solution.

Acid value [mg KOH/g]=(S−B)×f×5.61/M

Volume Average Particle Diameter Dv and Particle Diameter Distribution Dv/Dn of Toner

The volume average particle diameter Dv, number average particle diameter Dn, and particle diameter distribution Dv/Dn of the toner are measured through particle diameter measuring equipment (manufactured by Beckman Coulter, Inc., product name: Multisizer). Measurement through this multisizer is performed in conditions of aperture diameter: 100 μm, dispersive medium: Isoton II (product name), concentration 10%, the number of measured particles: 100,000.

Specifically, 0.2 g of toner is put into a beaker and alkyl benzene sulfonate aqueous solution (manufactured by Fujifilm Corporation, product name: Driwel) is added thereto as a dispersing agent. 2 mL of dispersive medium is additionally added thereto to moisten the toner, 10 mL of dispersive medium is added, dispersion is performed in an ultrasonic disperser for 1 minute, and then measurement through the aforementioned particle diameter measuring equipment is performed.

Binder Resin (A), Method of Specifying Structure of Diester Compound Represented by Formula (3), and Method of Measuring Molar Ratio of Structure Represented by Formula (1) to Structure Represented by Formula (4) in Binder Resin (A)

The binder resin (A), the structure of the diester compound represented by formula (3), and a molar ratio of the structure represented by formula (1) to the structure represented by formula (4) in the binder resin (A) are specified using nuclear magnetic resonance spectrometric analysis (¹H-NMR) [400 MHz, CDCl₃, room temperature (25° C.)].

Measurement equipment: FT NMR equipment JNM-EX400 (manufactured by JEOL Ltd.)
Measurement frequency: 400 MHz
Pulse condition: 5.0 μs
Frequency range: 10500 Hz
Cumulative number: 64 times
Solvent: deuteration solvent for dissolving the toner is appropriately used.

Method of Separating Binder Resin (B) and Wax from Toner

The toner is dissolved in tetrahydrofuran (THF) and the solvent is distilled under reduced pressure from the acquired soluble element to obtain a tetrahydrofuran (THF) soluble component of the toner.

The obtained tetrahydrofuran (THF) soluble component of the toner is dissolved in chloroform to prepare a sample solution in a concentration of 25 mg/ml. 3.5 ml of the obtained sample solution is inserted into the equipment described below and low molecular weight components derived from the wax which have molecular weights of less than 2000 and high molecular weight components derived from the binder resin which have molecular weights of at least 2000 are isolated in conditions described below. Isolation conditions are as follows.

Isolation GPC equipment: isolation HPLC LC-980 type manufactured by Japan Analytical Industry Co., Ltd.
Column for isolation: JAIGEL 3H, JAIGEL 5H (manufactured by Japan Analytical Industry Co., Ltd.)

### Eluent: Chloroform

Flow rate: 3.5 ml/min

After isolation, the solvent is distilled under reduced pressure and drying is additionally performed for 24 hours under reduced pressure in the ambient of 90° C.

Method of Separating Binder Resin (A) from Surface Layer of Photosensitive Member

The surface layer of the photosensitive member is dissolved in tetrahydrofuran (THF) and the solvent is distilled under reduced pressure from the acquired soluble element to obtain a tetrahydrofuran (THF) soluble component of the surface layer of the photosensitive member.

The obtained tetrahydrofuran (THF) soluble component of the surface layer of the photosensitive member is dissolved in chloroform to prepare a sample solution in a concentration of 25 mg/ml. 3.5 ml of the obtained sample solution is inserted into the equipment described below and isolated in conditions described below. Isolation conditions are as follows.

Isolation GPC equipment: isolation HPLC LC-980 type manufactured by Japan Analytical Industry Co., Ltd.
Column for isolation: JAIGEL 3H, JAIGEL 5H (manufactured by Japan

### Analytical Industry Co., Ltd.)

### Eluent: Chloroform

Flow rate: 3.5 ml/min

After isolation, the solvent is distilled under reduced pressure and drying is additionally performed for 24 hours under reduced pressure in the ambient of 90° C.

Method of Calculating Polarity Term sp Based on Hansen Solubility Parameters

A three-dimensional vector of Hansen solubility parameters is calculated through the following method.

(1): Hansen solubility parameters (δd, δp, δh), a molar volume and a molecular weight of each unit derived from each monomer that is a precursor of a vinyl resin or polyester (hereinafter referred to as a monomer unit) are calculated using the aforementioned solubility parameter calculation software.

Monomer used for vinyl resin: calculation is performed in a state in which unknown halogen X that does not affect a calculation result has been added to a double bond that is cleaved through polymerization as represented by formula (A) below.

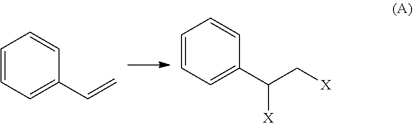

Monomer used for compound having at least one ester bond: calculation is performed in a state in which one of functional groups in a monomer that condensation-reacts have been changed to [—C(═O)O—X] or [XC(═O)—O—] and another functional group has been substituted with X, as represented by formula (B) below.

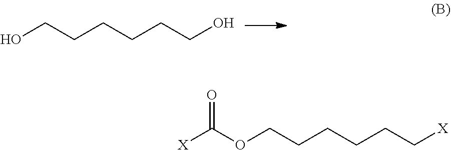

Monomer used for compound having at least one carbonate bond: calculation is performed in a state in which one of functional groups in a monomer that condensation-reacts have been changed to [—O—C(═O)O—X] and another functional group has been substituted with X, as represented by formula (C) below.

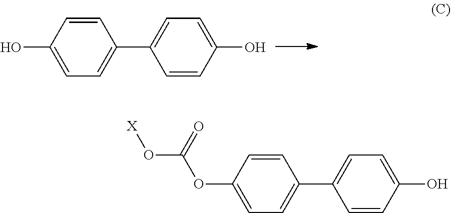

Other monomers that are condensed through dehydration: When condensation occurs through reaction represented by formula (D) below, solubility parameters of each monomer are calculated in a state in which one terminal of the monomer has been composed of linking groups J and X and other terminal has been substituted with X, as represented by formulas (E) and (F) below.

G-Ra-G+H—Rb—H→(Ra-J-Rb)ₙ (D)

X-J-Ra—X (E)

X-J-Rb—X (F)

In formulas (D) to (F), G and H are reactive functional groups, J is a linking group, and Ra and Rb are organic groups.

(2): Molar volume ratios of units derived from each monomer are calculated from a molar ratio of each monomer unit in a polymer and the molar volume of each unit.

(3): The sum of values obtained by multiplying the molar volume ratios by the Hansen solubility parameter δd of each monomer unit is regarded as the Hansen solubility parameter δd of the polymer. δp and δh are calculation in the same manner.

A method of deriving solubility parameters when the binder resin (B) and the wax are mixtures of at least two types of materials is as follows.

First, solubility parameters (δd, δp, δh) of the respective materials are derived. Then, values obtained by calculating arithmetic means of parameter values δd, parameter values δp and parameter values δh of each material are used as the solubility parameters (δd, δp, δh) of the mixtures.

Method of Measuring Content of Wax

The content X of the wax in the toner is measured using thermal analysis equipment (DSC Q2000 manufactured by TA Instruments).

First, approximately 5.0 mg of a toner sample is put into a sample container of an aluminum pan (KITNO. 0219-0041), the sample container is loaded on a holder unit and set in an electric furnace.

Heating is performed at a temperature increase rate of 10° C./min from 30° C. to 200° C. in a nitrogen ambient, a DSC curve is measured using the differential scanning calorimetry (DSC), and the endothermic quantity of the wax in the toner sample is calculated. In addition, the endothermic quantity is calculated through the same method using approximately 5.0 mg of a wax simple body sample. Then, the content of the wax is obtained using formula (14) described below using the obtained endothermic quantities of the wax.

Content X (mass %) of wax in toner=(endothermic quantity (J/g) of wax in toner sample)/(endothermic quantity (J/g) of wax simple body)×100 (14)

### EXAMPLES

Hereinafter, the present disclosure will be described in more detail using examples and comparative examples. The present disclosure is not limited by examples described below unless it departs from the gist thereof. Meanwhile, in the following description of examples, “part” is a mass basis unless otherwise particularly noted.

### Example of Manufacturing Binder Resin (A)1

The following materials are prepared.
13.3 parts of diol represented by formula (15) below

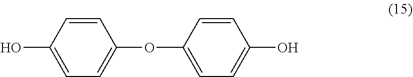 [SMILES: Oc1ccc(Oc2ccc(O)cc2)cc1]

36.7 parts of diol represented by formula (16) below

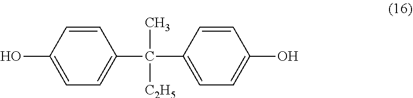 [SMILES: CCC(C)(c1ccc(O)cc1)c1ccc(O)cc1]

0.1 part of hydrosulfite

These materials were dissolved in 1100 parts of 5 mass % sodium hydroxide aqueous solution. While 500 parts of methylene chloride were added thereto, agitated, and maintained at 15° C., 60.0 parts of phosgene were blown therein for 60 minutes.

After completion of phosgene blowing, 1.0 parts of p-t-butylphenol as a molecular-weight adjusting agent were added and agitated to emulsify the reaction solution. After emulsification, 0.3 parts of trimethylamine were added, agitated at 23° C. for 1 hour and polymerized.

After polymerization, the reaction solution was separated into an aqueous phase and an organic phase, the organic phase was neutralized with phosphate and water washing was repeated until the conductivity of a washing solution (aqueous phase) became not more than 10 μS/cm. The obtained polymer solution was dropped to warm water maintained at 45° C. and the solvent was removed through vaporization to obtain white power form precipitate. The obtained precipitate was filtered and dried at 110° C. for 24 hours to obtain a binder resin (A)1.

As a result of checking the obtained binder resin (A)1 with ¹H-NMR, the binder resin (A)1 was a resin having 30 mol % of the structure represented by formula (1) and 70 mol % of the structure represented by formula (4). The weight average molecular weight (Mw) of the binder resin (A)1 was 110,000. Characteristics of the obtained binder resin (A)1 was shown in Table 2.

### Example of Manufacturing Binder Resins (A)2 to 13

Binder resins (A)2 to 13 were manufactured in the same conditions as those of the example of manufacturing the binder resin (A)1 except that the type of diol to be used was changed such that R₁₁ in formula (1) and R₂₁ to R₂₃ in formula (4) became as shown in Table 2 and the molar ratio and quantities of the structure represented by formula (1) and the structure represented by formula (4) were changed as shown in Table 2. Characteristics of the obtained binder resins (A)2 to 13 were shown in Table 2.

### Example of Manufacturing Photosensitive Member 1

3.0 parts of non-metallic phthalocyanine pigment as a charge generation material agent,

60.0 parts of a compound represented by formula (17) below as a charge transport material,

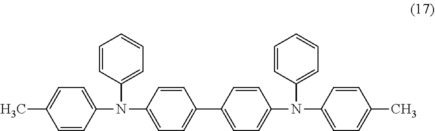

12.0 parts of the compound represented by the aforementioned (E4-1) and 28.0 parts of the compound represented by the aforementioned (E5-1) as an electron transport material,

100 parts of the binder resin (A)1 as a binder resin, and

800 parts of tetrahydrofuran as a solvent were put into a container.

The materials and the solvent in the container were mixed for 2 minutes using a bar type ultrasonic dispersing device to disperse the materials in the solvent. Further, the materials and the solvent were mixed for 50 hours using a ball mill to disperse the materials in the solvent and adjust a coating solution for a photosensitive member.

This coating solution for a photosensitive member was immersion-coated on an aluminum support as a conductive base and dried at 100° C. for 40 minutes to manufacture a photosensitive member 1 having a film thickness of 25 μm and a single layer type photosensitive layer. The single layer type photosensitive layer corresponds to the surface layer of the photosensitive member 1.

### Example of Manufacturing Photosensitive Members 2 to 11, 13 and 14

Photosensitive members 2 to 11, 13 and 14 were manufactured in the same conditions as those of the example of manufacturing the photosensitive member 1 except that the binder resin (A)1 was changed as shown in Table 2. The photosensitive members 2 to 11, 13 and 14 are all photosensitive members having single layer type photosensitive layers, and the single layer type photosensitive layers correspond to the surface layers of the photosensitive members.

### Example of Manufacturing Photosensitive Member 12

3.0 parts of non-metallic phthalocyanine pigment as a charge generation material,

60.0 parts of the compound represented by the above formula (17) below as a charge transport material,

12.0 parts of the compound represented by the aforementioned (E4-1) and 28.0 parts of the compound represented by the aforementioned (E5-1) as an electron transport material,

1.0 parts of silica particles (RX200 manufactured by Nippon Aerosil Co., Ltd.) surface-treated with hexamethyldisilazane as an additive,

100 parts of the binder resin (A)1 as a binder resin, and

800 parts of tetrahydrofuran as a solvent were put into a container.

The materials and the solvent in the container were mixed for 2 minutes using a bar type ultrasonic dispersing device to disperse the materials in the solvent. Further, the materials and the solvent were mixed for 50 hours using a ball mill to disperse the materials in the solvent and adjust a coating solution for a photosensitive member.

This coating solution for a photosensitive member was immersion-coated on an aluminum support as a conductive base and dried at 100° C. for 40 minutes to manufacture a photosensitive member 12 having a film thickness of 25 μm and a single layer type photosensitive layer. The single layer type photosensitive layer corresponds to the surface layer of the photosensitive member 12.

TABLE 2

| Photo- | | Binder | Formula | | | | (1):(4) | Binder | Binder |
|---|---|---|---|---|---|---|---|---|---|
| sensitive | | resin | (1) | Formula (4) | | | Molar | resin | resin |
| member | Silica | No. | R₁₁ | R₂₁ | R₂₂ | R₂₃ | ratio | Mw | δp(A) |
| 1 | Absent | (A)1 | H | H | Methyl | Ethyl | 30:70 | 110,000 | 8.1 |
| 2 | Absent | (A)2 | H | H | Methyl | Ethyl | 25:75 | 90,000 | 8.1 |
| 3 | Absent | (A)3 | H | H | Methyl | Ethyl | 40:60 | 80,000 | 8.1 |
| 4 | Absent | (A)4 | H | H | Methyl | Ethyl | 20:80 | 150,000 | 8.1 |
| 5 | Absent | (A)5 | H | H | * | | 30:70 | 100,000 | 8.1 |
| 6 | Absent | (A)6 | H | H | Methyl | Methyl | 30:70 | 90,000 | 8.1 |
| 7 | Absent | (A)7 | H | H | H | Methyl | 30:70 | 100,000 | 8.1 |
| 8 | Absent | (A)8 | H | H | Methyl | Phenyl | 30:70 | 90,000 | 8.1 |
| 9 | Absent | (A)9 | Methyl | H | Methyl | Ethyl | 30:70 | 110,000 | 5.8 |
| 10 | Absent | (A)10 | H | Methyl | Methyl | Methyl | 30:70 | 110,000 | 8.1 |
| 11 | Absent | (A)11 | Methyl | Methyl | Methyl | Ethyl | 30:70 | 100,000 | 5.8 |
| 12 | Present | (A)1 | H | H | Methyl | Ethyl | 30:70 | 110,000 | 8.1 |
| 13 | Absent | (A)12 | — | H | Methyl | Ethyl | 0:100 | 110,000 | 8.1 |

| | | | | | | | | |
|---|---|---|---|---|---|---|---|---|
| 14 | Absent | (A)13 | — | H | * | 0:100 | 160,000 | 8.1 |

In Table 2, * represents that R₂₂ and R₂₃ are connected to each other to form cyclohexylidene.

### Example of Manufacturing Wax 1

300 parts of xylene, 15.5 parts of ethylene glycol, and 170 parts of stearic acid were added to a reactor including an agitator, a thermometer, a nitrogen introduction pipe, a dewatering conduit, and a decompression device and heated to a temperature of 130° C. while being agitated. Thereafter, 0.41 parts of di(2-ethylhexanoic acid) tin were added as an esterification catalyst, the temperature was increased to 200° C. and condensation was performed. After reaction, the solvent was removed to obtain a wax 1. Physical properties of the wax are shown in Table 3.

### Example of Manufacturing Waxes 2 to 5

Waxes 2 to 5 were manufactured through the same method as the example of manufacturing the wax 1 except that an alcohol monomer and an acid monomer have been changed as shown in Table 3. Physical properties of the waxes 2 to 5 are shown in Table 3.

Waxes 6 to 8

As a wax 6, DP-16 (product name, manufactured by The Nisshin OilliO Group, Ltd.) that is palmitic acid ester of dipentaerythritol was used.

As a wax 7, PE-18 (product name, manufactured by The Nisshin OilliO Group, Ltd.) that is stearic acid ester of pentaerythritol was used.

As a wax 8, Paraffin Wax (manufactured by Nippon Seiro Co., Ltd., product name: HNP-11) was used.

Physical properties of the waxes 6 to 8 are shown in Table 3.

TABLE 3

| | | | R₂, R₃ | | | R₁ | | | | |
|---|---|---|---|---|---|---|---|---|---|---|
| | | | Number | | | Number | Acid | | | |
| | Acid monomer | | of | Alcohol monomer | | of | value | Melting | | |
| | Compound | | carbon | Compound | | carbon | (mgKOH/ | point | | |
| Wax | name | Part | atoms | name | Part | atoms | g) | (° C.) | δp(w) | SP2 |
| 1 | Stearic acid | 170 | 17 | Ethylene glycol | 15.5 | 2 | 0.1 | 75 | 2.1 | 18.11 |
| 2 | Behenic acid | 204 | 21 | Ethylene glycol | 15.5 | 2 | 0.1 | 85 | 1.8 | 18.01 |
| 3 | Stearic acid | 170 | 17 | Trimethylene | 18.5 | 3 | 0.1 | 76 | 1.8 | 18.09 |
| | | | | glycol | | | | | | |
| 4 | Capric acid | 103 | 9 | Ethylene glycol | 15.5 | 2 | 0.1 | 70 | 2.8 | 18.49 |
| 5 | Lignoceric | 220 | 23 | Ethylene glycol | 15.5 | 2 | 0.1 | 67 | 1.5 | 17.97 |
| | acid | | | | | | | | | |

| | | | | | |
|---|---|---|---|---|---|
| 6 | DP16 | 0.5 | 71 | 2.4 | 18.44 |
| 7 | PE18 | 0.2 | 76 | 1.7 | 18.27 |
| 8 | HNP11 | 0.0 | 68 | 0.0 | 8.11 |

### Example of Manufacturing Toner 1

Polymerizable monomer: 75 parts of styrene, 25 parts of n-butylacrylate
Colarant: 7 Parts of carbon black (manufactured by Mitsubishi Chemical Corporation, product name: #25B)
Crosslinking agent: 0.74 parts of divinyl benzene
Charge control agent: 0.37 parts of styrene/acrylic resin (manufactured by Fujikura Kasei Co., Ltd., product name: FCA-592P)
Molecular-weight adjusting agent: 1 part of tetraethylthiuramdisulfide
Macromonomer: 0.25 parts of polymetacylic acid ester macromonomer (manufactured by Toagosei Co., Ltd., product name: AA6, Tg=94° C.)

After the aforementioned materials were agitated and mixed using a conventional agitating device, the materials were uniformly dispersed through a media type disperser and heated to 63° C.

20 parts of the wax 1 were added thereto, mixed and dissolved to obtain a polymerizable monomer composition.

On the other hand, an aqueous solution obtained by dissolving 4.1 parts of sodium hydroxide in 50 parts of ion exchange water was slowly added to an aqueous solution obtained by dissolving 7.4 parts of magnesium chloride in 250 parts of ion exchange water during agitation in an agitation tank at a room temperature to prepare a magnesium hydroxide clloid dispersing solution (3.0 parts of magnesium hydroxide).

The aforementioned polymerizable monomer composition was put into the magnesium hydroxide clloid dispersing solution obtained as above at the room temperature, heated to 60° C., agitated until droplets are stabilized, 5 parts of t-butyl peroxy-2-ethylhexanoate (manufactured by NOF Corporation, product name: Perbutyl O) were added thereto as a polymerization initiator, and then high-shearing-agitated at 15,000 rpm using an inline-type emulsification disperser (manufactured by Pacific Machinery & Engineering Co., Ltd., product name: Milder) to form droplets of the polymerizable monomer composition.

The magnesium hydroxide clloid dispersing solution in which the droplets of the polymerizable monomer composition were dispersed was put into a reactor equipped with an agitation tank, heated to 89° C. and controlled such that the temperature is uniform, and polymerization reaction was performed. Subsequently, when a polymerization conversion rate reached 98%, the temperature in the system was cooled to 75° C., and after 15 minutes from arrival at 75° C., 3 parts of methyl methacrylate as a polymerizable monomer for a shell and 0.36 parts of 2,2′-azobis [2-methyl-N-(1,1-bis (hydroxymethyl) 2-hydroxyethyl) propionamide] tetrahydrate (manufactured by Wako Pure Chemical Industries, Ltd., product name: VA086) dissolved in 10 parts of ion exchange water were added. After polymerization further continued for 3 hours, reaction was stopped and an aqueous dispersion with colored resin particles with pH 9.5 was obtained.

Thereafter, the aqueous dispersion with the colored resin particles was heated to 80° C., stripping processing was performed with a nitrogen gas flow rate of 0.6 m³/(hr·kg) for 5 hours, and then the aqueous dispersion was cooled to 25° C. Subsequently, pH of the system was set to 6.5 or less using sulfuric acid and acid washing was performed while the obtained aqueous dispersion was being agitated at 25° C., water was separated through filtering, and then 500 parts of ion exchange water was newly added and re-slurrying was performed to execute water washing. Thereafter, dehydration and water washing were repeated again several times, solid content was filtered/separated, and then the resultant was put into a drier and dried at a temperature of 40° C. for 12 hours to obtain toner particles 1.

0.7 parts of hydrophobized silica particles with a number average primary particle diameter of 7 nm and 1 part of hydrophobized silica particles with a number average primary particle diameter of 50 nm were added to 100 parts of toner particles 1 and mixed using a high-speed agitator (manufactured by Nippon Coke & Engineering Co., Ltd., product name: FM Mixer) to manufacture toner 1. Physical properties of the obtained toner 1 are shown in Table 4.

Example of Manufacturing Toners 2 to 12

Toners of toners 2 to 12 were made in the same conditions as those in the example of manufacturing toner 1 except that the type and dosage of the wax were changed as shown in Table 4 in the example of manufacturing toner 1. Characteristics of the obtained toners are shown in Table 4.

TABLE 4

| | No. | Toner 1 | Toner 2 | Toner 3 | Toner 4 | Toner 5 | Toner 6 | Toner 7 | Toner 8 | Toner 9 | Toner 10 | Toner 11 | Toner 12 |
|---|---|---|---|---|---|---|---|---|---|---|---|---|---|
| | Dosage | Wax 1 | Wax 2 | Wax 3 | Wax 6 | Wax 1 | Wax 1 | Wax 1 | Wax 1 | Wax 8 | Wax 7 | Wax 4 | Wax 5 |
| Wax | (Parts) | 20 | 20 | 20 | 20 | 5 | 30 | 0.5 | 33 | 20 | 20 | 20 | 20 |

| | | | | | | | | | | | | |
|---|---|---|---|---|---|---|---|---|---|---|---|---|
| SP1-SP2 | 1.96 | 2.06 | 1.98 | 1.63 | 1.96 | 1.96 | 1.96 | 1.96 | 11.96 | 1.80 | 1.58 | 2.10 |
| Dv (μm) | 7.7 | 7.8 | 7.6 | 7.6 | 7.7 | 7.8 | 7.9 | 7.6 | 7.8 | 7.6 | 7.9 | 7.5 |
| Dv/Dn | 1.15 | 1.16 | 1.15 | 1.16 | 1.17 | 1.16 | 1.15 | 1.16 | 1.17 | 1.16 | 1.15 | 1.14 |
| Tm (° C.) | 125 | 128 | 125 | 126 | 129 | 121 | 132 | 119 | 128 | 124 | 126 | 125 |
| Tg (° C.) | 53 | 52 | 53 | 55 | 54 | 50 | 55 | 49 | 56 | 55 | 53 | 53 |
| Mn | 8,600 | 8,700 | 8,500 | 8,800 | 8,700 | 8,600 | 8,500 | 8,600 | 8,800 | 8,600 | 8,600 | 8,700 |
| Mw | 243,000 | 253,400 | 258,600 | 264,000 | 256,300 | 268,900 | 254,600 | 268,500 | 256,400 | 256,900 | 274,600 | 258,900 |
| Mw/Mn | 28.3 | 29.1 | 30.4 | 30.0 | 29.5 | 31.3 | 30.0 | 31.2 | 29.1 | 29.9 | 31.9 | 29.8 |

### Example 1

Evaluation described below was performed using a combination of the toner 1 and the photosensitive member 1.

Evaluation of Low-Temperature Fixability

For evaluation of low-temperature fixability, an external fixing unit modified in such a manner that the fixing unit of HL-5470DW (monochromatic laser printer manufactured by Brother Industries, Ltd.) is taken out to the outside such that the temperature of the fixing unit can be arbitrarily set and a process speed becomes 400 mm/sec was used.

An unfixed image in which a toner mounting amount per unit area has been set to 0.5 mg/cm² was caused to pass through the fixing unit for which the temperature has been controlled to 150° C. using the aforementioned device in a low-temperature low-humidity environment (temperature 15° C. and humidity 5% RH). Meanwhile, “Prober Bond Paper” (105 g/m², manufactured by Fox River) was used as a recording medium. The obtained fixed image was rubbed in a reciprocating manner five times with cleaning paper to which a load of 4.9 kPa (50 g/cm²) has been applied and image concentration reduction rates (%) before and after rubbing were evaluated. Results are shown in Table 5.

A: Image concentration reduction rate is less than 10.0%
B: Image concentration reduction rate is at least 10.0% and less than 15.0%
C: Image concentration reduction rate is at least 15.0% and less than 20.0%
D: Image concentration reduction rate is at least 20.0%

Storage Stability

With respect to storage stability, 10 g of toner 1 was weighed using a 50 mL plastic cup, leaved in a thermostat at 55° C. for 3 days, and then a blocking property was visually evaluated using the following evaluation standards. Evaluation results are shown in Table 5.

A: It is not hardened at all.
B: Although there are lumps, they become small to be loosened while the cup is rotated.
C: Lumps remain even when they are loosened by rotating the cup.
D: There is a large lump and it is not loosened even when the cup is rotated.

Evaluation of Omission During Transfer

Evaluation of omission during transfer was performed as follows.

100 sheets of paper were continuously fed for a horizontal-line image with a printing rate of 5% and then a toner quantity on the paper was adjusted to be 0.6 mg/cm² using HL-5470DW (monochromatic laser printer manufactured by Brother Industries, Ltd.) in a low-temperature low-humidity environment (temperature 32.5° C. and humidity 80% RH).

An image was formed such that fine lines were present thereon in both vertical and horizontal directions, two lines of 2, 4, 6, 8 and 10 dot lines were printed such that a non-latent part width between lines became approximately 1 mm, and results from visual observation and observation using a 20-times magnifier were evaluated according to the following standards. Evaluation results are shown in Table 5.

A: Omissions could be hardly confirmed through magnifying observation in two dot lines.
B: Although some omissions were confirmed through magnifying observation, no omissions could be visually confirmed in two dot lines.
C: Although omissions could be visually confirmed in two dot lines, no omissions could be visually confirmed in four dot lines.
D: Omissions could be visually confirmed in four dot lines.

### Examples 2 to 19, Comparative Examples 1 to 6

Examples 2 to 19 and Comparative examples 1 to 6 were examined in the same conditions as those in Example 1 except that the toner and the photosensitive member were changed as shown in Table 5. Results are shown Table 5.

TABLE 5

| | | | | Low- | | | |
|---|---|---|---|---|---|---|---|
| | | | | temperature | | | |
| | | | | fixability | | O- | Stor- |
| | | | δp | | Con- | mission | age |
| | | Photo- | (A)- | | centration | during | sta- |
| | Ton- | sensitive | δp | | reduction | transfer | bility |
| | er | member | (w) | Rank | rate (%) | rank | rank |
| Example 1 | 1 | 1 | 6.0 | A | 8.5 | A | A |
| Example 2 | 2 | 1 | 6.3 | B | 12.6 | A | A |
| Example 3 | 3 | 1 | 6.3 | B | 13.8 | A | A |
| Example 4 | 4 | 1 | 5.7 | C | 15.6 | B | A |
| Example 5 | 5 | 1 | 6.0 | B | 14.8 | B | A |
| Example 6 | 6 | 1 | 6.0 | A | 7.3 | A | B |
| Example 7 | 7 | 1 | 6.0 | C | 16.8 | B | A |
| Example 8 | 8 | 1 | 6.0 | A | 6.5 | A | C |
| Example 9 | 1 | 2 | 6.0 | A | 8.3 | B | A |
| Example 10 | 1 | 3 | 6.0 | A | 8.4 | A | A |
| Example 11 | 1 | 4 | 6.0 | A | 8.6 | C | A |
| Example 12 | 1 | 5 | 6.0 | A | 8.5 | A | A |
| Example 13 | 1 | 6 | 6.0 | A | 8.1 | A | A |
| Example 14 | 1 | 7 | 6.0 | A | 8.3 | A | A |
| Example 15 | 1 | 8 | 6.0 | A | 8.6 | A | A |
| Example 16 | 1 | 9 | 3.7 | A | 8.9 | A | A |
| Example 17 | 1 | 10 | 6.0 | A | 8.5 | A | A |
| Example 18 | 1 | 11 | 3.7 | A | 8.6 | A | A |
| Example 19 | 1 | 12 | 6.0 | A | 8.7 | A | A |
| Comparative | 9 | 1 | 8.1 | D | 29.8 | D | A |
| example 1 | | | | | | | |
| Comparative | 10 | 1 | 6.4 | D | 25.3 | D | A |
| example 2 | | | | | | | |
| Comparative | 11 | 1 | 5.3 | D | 21.3 | D | A |
| example 3 | | | | | | | |
| Comparative | 12 | 1 | 6.6 | C | 18.6 | D | D |
| example 4 | | | | | | | |
| Comparative | 2 | 13 | — | B | 12.3 | D | A |
| example 5 | | | | | | | |
| Comparative | 2 | 14 | — | B | 12.9 | D | A |
| example 6 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-237079, filed Dec. 26, 2019 which is hereby incorporated by reference herein in its entirety.

What is claimed is:

1. An image forming apparatus comprising:
an electrophotographic photosensitive member; and
a developing device comprising a toner, the developing device being for supplying the toner to the electrophotographic photosensitive member, wherein
the electrophotographic photosensitive member comprises a surface layer comprising a binder resin (A),
the binder resin (A) comprises a structure represented by the following formula (1): 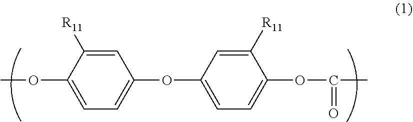
where, each R₁₁ independently represents a hydrogen atom or a methyl group,
the toner comprises a toner particle,
the toner particle comprises a binder resin (B) and a wax, and
the wax has a value δp(w) of a polarity term based on Hansen solubility parameters of 1.8 to 2.5 (J/cm³)^{0.5}.

2. The image forming apparatus according to claim 1, wherein, when SP value of the binder resin (B) is defined as SP1 ((J/cm³)^{0.5}), and SP value of the wax is defined as SP2 ((J/cm³)^{0.5}), the SP1 and the SP2 satisfy the following formula (2):
1.80≤SP1−SP2≤2.10 (2).

3. The image forming apparatus according to claim 1, wherein the wax comprises a diester compound represented by the following formula (3): 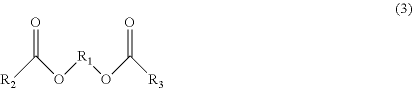
where, R₁ represents an alkylene group having a number of carbon atoms of 1 to 3, and R₂ and R₃ independently represent alkylene groups having a number of carbon atoms of 15 to 22.

4. The image forming apparatus according to claim 1, wherein a content of the wax is 5 to 30 parts by mass with respect to 100 parts by mass of the binder resin (B).

5. The image forming apparatus according to claim 1, wherein the binder resin (A) further comprises a structure represented by the following formula (4): 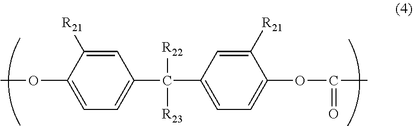
where, each R₂₁ independently represents a hydrogen atom or a methyl group, and R₂₂ and R₂₃ independently represent hydrogen atoms, methyl groups, ethyl groups or phenyl groups, or R₂₂ and R₂₃ are linked to each other to form a cycloalkylidene group.

6. The image forming apparatus according to claim 5, wherein a molar ratio of a structure represented by the formula (1) to a structure represented by the formula (4) in the binder resin (A) is satisfies following formula:
the structure represented by formula (1):the structure represented by formula (4)=5:95 to 95:5.

7. The image forming apparatus according to claim 5, wherein, in the formula (4), R₂₂ is a methyl group and R₂₃ is an ethyl group.

8. The image forming apparatus according to claim 1, wherein, when a value of a polarity term based on Hansen solubility parameters of the structure represented by the formula (1) is defined as δp(A) ((J/cm³)^{0.5}), the δp(A) and the δp(w) are satisfy the following formula:
5.8≤δp(A)−δp(w)≤6.5.

9. A process cartridge attached detachably to a main body of an image forming apparatus, the process cartridge comprising:
an electrophotographic photosensitive member; and
a developing device comprising a toner, the developing device being for supplying the toner to the electrophotographic photosensitive member, wherein
the electrophotographic photosensitive member comprises a surface layer comprising a binder resin (A),
the binder resin (A) comprises a structure represented by the following formula (1): 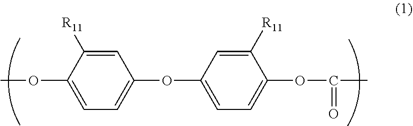
where, each R₁₁ independently represents a hydrogen atom or a methyl group,
the toner comprises a toner particle,
the toner particle comprises a binder resin (B) and a wax, and
the wax has a value δp(w) of a polarity term based on Hansen solubility parameters of 1.8 to 2.5 (J/cm³)^{0.5}.

10. A cartridge set comprising a first cartridge and a second cartridge attached detachably to a main body of an image forming apparatus, wherein
the first cartridge comprises an electrophotographic photosensitive member,
the second cartridge comprises a toner container comprising a toner for developing an electrostatic latent image formed on a surface of the electrophotographic photosensitive member to form a toner image on the surface of the electrophotographic photosensitive member,
the electrophotographic photosensitive member comprises a surface layer comprising a binder resin (A),
the binder resin (A) comprises a structure represented by the following formula (1): 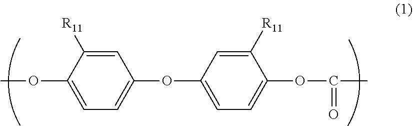
where, each R₁₁ independently represents a hydrogen atom or a methyl group,
the toner comprises a toner particle,
the toner particle comprises a binder resin (B) and a wax, and
the wax has a value δp(w) of a polarity term based on Hansen solubility parameters of 1.8 to 2.5 (J/cm³)^{0.5}.

11. An image forming method in which an electrophotographic photosensitive member and a toner are used,
the method comprising a developing process of supplying the toner to the electrophotographic photosensitive member, wherein
the electrophotographic photosensitive member comprises a surface layer comprising a binder resin (A),
the binder resin (A) comprises a structure represented by the following formula (1): 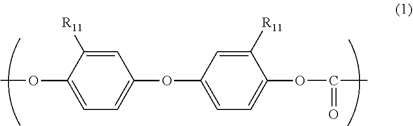
where, each R₁₁ independently represents a hydrogen atom or a methyl group,
the toner comprises a toner particle,
the toner particle comprises a binder resin (B) and a wax, and
the wax has a value δp(w) of a polarity term based on Hansen solubility parameters of 1.8 to 2.5 (J/cm³)^{0.5}.

12. An image forming apparatus comprising:
an electrophotographic photosensitive member; and
a developing device comprising a toner, the developing device being for supplying the toner to the electrophotographic photosensitive member, wherein
the electrophotographic photosensitive member comprises a surface layer comprising a binder resin (A),
the binder resin (A) comprises a structure represented by the following formula (1): 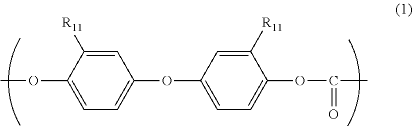
where, each R₁₁ independently represents a hydrogen atom or a methyl group,
the toner comprises a toner particle,
the toner particle comprises a binder resin (B) and a wax, and
the wax comprises a diester compound represented by the following formula (3): 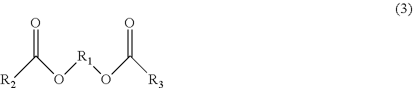
where, R₁ represents an alkylene group having a number of carbon atoms of 1 to 3, and R₂ and R₃ independently represent alkylene groups having a number of carbon atoms of 15 to 22.

13. The image forming apparatus according to claim 12, wherein a content of the wax is 5 to 30 parts by mass with respect to 100 parts by mass of the binder resin (B).

14. The image forming apparatus according to claim 12, wherein the binder resin (A) further comprises a structure represented by the following formula (4): 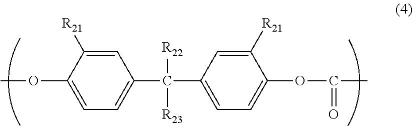
where, each R₂₁ independently represents a hydrogen atom or a methyl group, and R₂₂ and R₂₃ independently represent hydrogen atoms, methyl groups, ethyl groups or phenyl groups, or R₂₂ and R₂₃ are linked to each other to form a cycloalkylidene group.

15. The image forming apparatus according to claim 12, wherein a molar ratio of a structure represented by the formula (1) to a structure represented by the formula (4) in the binder resin (A) is satisfies following formula:
the structure represented by formula (1):the structure represented by formula (4)=5:95 to 95:5.

16. The image forming apparatus according to claim 12, wherein, in the formula (4), R₂₂ is a methyl group and R₂₃ is an ethyl group.
